(19) United States
(12) Patent Application Publication
(10) Pub. No.: US 2022/0014059 A1
(43) Pub. Date: Jan. 13, 2022

(54) ELECTRIC MOTOR AND ELECTRIC MOTOR SYSTEM PROVIDED WITH SAME

(71) Applicant: DAIKIN INDUSTRIES, LTD., Osaka (JP)

(72) Inventors: Tomoki Nakata, Osaka (JP); Takeshi Araki, Osaka (JP)

(21) Appl. No.: 17/486,644

(22) Filed: Sep. 27, 2021

Related U.S. Application Data
(63) Continuation of application No. PCT/JP2020/012648, filed on Mar. 23, 2020.

(30) Foreign Application Priority Data
Mar. 28, 2019 (JP) 2019-062129

(51) Int. Cl. H02K 1/27; H02K 1/28; H02K 15/03

(52) U.S. Cl. CPC H02K 1/2773; H02K 15/03; H02K 1/28

(57) ABSTRACT

An electric motor includes a rotor, and a stator. The rotor has a core, shaft rotatably supported on the core only on one axial side, and plurality of permanent magnets forming magnetic poles. In a case in which each of the magnetic poles is divided into rotation and reverse direction sides relative to a magnetic pole center, the rotor core has magnetic saturation promoting portion by which a half portion on the rotation direction side of at least one of the magnetic poles each including a corresponding one of the permanent magnets is likely to be magnetically saturated. The magnetic saturation promoting portion is provided in a more radially outward direction than the permanent magnet. Shapes of the half portions on the rotation and reverse direction sides are asymmetric about a first straight line passing through the pole center of the magnetic pole and an axial center of the rotor.

### CROSS-REFERENCE TO RELATED APPLICATIONS

This is a continuation of International Application No. PCT/JP2020/012648 filed on Mar. 23, 2020, which claims priority to Japanese Patent Application No. 2019-062129, filed on Mar. 28, 2019. The entire disclosures of these applications are incorporated by reference herein.

### BACKGROUND

### Field of Invention

The present disclosure relates to an electric motor and an electric motor system provided with the same.

### Background Information

Japanese Unexamined Patent Application Publication No. 2017-108626 discloses an electric motor including a rotor core in which a plurality of magnet insertion holes are formed. The electric motor according to PTL 1 is provided with a plurality of slits in a radially outward direction of the magnet insertion holes in the rotor core, and the slits have a first portion and a second portion. The distance from a magnetic pole center line to the first portion increases from a radially inward direction toward the radially outward direction. The distance from the magnetic pole center line to the second portion is fixed from the radially inward direction toward the radially outward direction. Such a structure can reduce vibration of the electric motor according to Japanese Unexamined Patent Application Publication No. 2017-108626.

### SUMMARY

A first aspect of the present disclosure is directed to an electric motor including a rotor, and a stator. The rotor has a rotor core, a shaft inserted into and fixed to the rotor core, and a plurality of permanent magnets forming a plurality of magnetic poles arranged in a circumferential direction. The magnetic poles are regions obtained by dividing the rotor in the circumferential direction depending on whether a magnetic field direction on a surface of the rotor is a radially outward direction or a radially inward direction. The shaft is rotatably supported on the rotor core only on one side of an axial direction. In a case in which each of the magnetic poles is divided into two, which are a rotation direction side and a reverse rotation direction side, relative to a pole center of the magnetic pole, the rotor core has magnetic saturation promoting portion by which a half portion on the rotation direction side of at least one of the magnetic poles each including a corresponding one of the permanent magnets is likely to be magnetically saturated. The magnetic saturation promoting portion is provided in a more radially outward direction than the permanent magnet. A shape of the half portion on the rotation direction side and a shape of a half portion on the reverse rotation direction side are asymmetric about a first straight line passing through the pole center of the magnetic pole and an axial center of the rotor.

### BRIEF DESCRIPTION OF THE DRAWINGS

FIG. 1 is a sectional view illustrating an example of a structure of a compressor according to a first embodiment.

FIG. 2 is a block diagram illustrating a motor and a configuration of a motor driving apparatus that drives the motor.

FIG. 3 is graphs illustrating relationships between control employed in an embodiment and a rotational speed as solid lines.

FIG. 4 is a flowchart illustrating control of an output circuit by a controller.

FIG. 5 is a graph illustrating a relationship between an axial deviation and a driving voltage in which the rotational speed is a parameter.

FIG. 6 is a graph illustrating a relationship between a current amplitude and the axial deviation in which the rotational speed is a parameter.

FIG. 7 is a graph illustrating a relationship between the rotational speed and the current amplitude when a torque is a predetermined value.

FIG. 8 is a graph illustrating a relationship between a phase of a current vector and the axial deviation in which the rotational speed is a parameter.

FIG. 9 is a graph illustrating a relationship between the rotational speed and the phase when the torque is a predetermined value.

FIG. 10 is a graph illustrating a relationship between a d-axis current and the axial deviation in which the rotational speed is a parameter.

FIG. 11 is a graph illustrating a relationship between a q-axis current and the axial deviation in which the rotational speed is a parameter.

FIG. 12 is a graph illustrating a relationship between the rotational speed and the q-axis current when the torque is a predetermined value.

FIG. 13 is a vector diagram illustrating a relationship between a field magnetic flux vector, a magnetic flux vector attributed to an armature reaction, and a primary magnetic flux vector.

FIG. 14 is a graph illustrating a relationship between a T-axis current and the axial deviation in which the rotational speed is a parameter.

FIG. 15 is a graph illustrating a relationship between the rotational speed and the T-axis current when the torque is a predetermined value.

FIG. 16 is a graph illustrating a relationship between a primary magnetic flux and the axial deviation in which the rotational speed is a parameter.

FIG. 17 is a graph illustrating a relationship between the rotational speed and the primary magnetic flux when the torque is a predetermined value.

FIG. 18 is a graph illustrating a relationship between a load angle and the axial deviation in which the rotational speed is a parameter.

FIG. 19 is a graph illustrating a relationship between the rotational speed and the load angle when the torque is a predetermined value.

FIG. 20 is a graph illustrating a relationship between an instantaneous actual electric power and the axial deviation in which the rotational speed is a parameter.

FIG. 21 is a graph illustrating a relationship between the rotational speed and the instantaneous actual electric power Pₒ when the torque is a predetermined value.

FIG. 22 is a block diagram illustrating a first modification of the controller.

FIG. 23 is a block diagram illustrating a second modification of the controller.

FIG. 24 is a plan view illustrating a structure of an electric motor according to the first embodiment.

FIG. 25 is a plan view of a rotor according to the first embodiment.

FIG. 26 is a plan view for explaining a definition of magnetic poles of the rotor.

FIG. 27 is a plan view of a rotor according to a modification of the first embodiment.

FIG. 28 is a plan view of a rotor according to a second embodiment.

FIG. 29 is a plan view of a rotor according to a third embodiment.

### DETAILED DESCRIPTION OF EMBODIMENT(S)

### First Embodiment

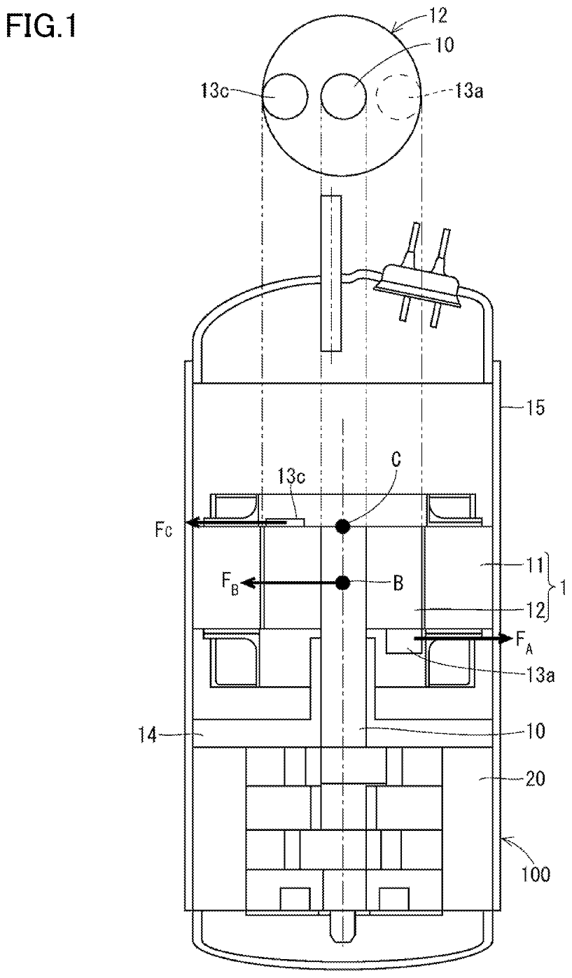

FIG. 1 is a sectional view illustrating an example of a structure of a compressor (100) employed for a refrigeration circuit, such as a heat pump. The compressor (100) includes a compression mechanism (20), an electric motor (1), a bearing (14), and a casing (15). The compression mechanism (20) compresses refrigerant (omitted from illustration). For example, a swing type is employed for the compression mechanism (20), and refrigerant is compressed by rotation transferred from the electric motor (1) via a shaft (10). The compression mechanism (20) is a load driven by the electric motor (1).

The electric motor (1) includes a stator (11) and a rotor (12). For example, the stator (11) and the rotor (12) are an armature and a field element, respectively. For example, the electric motor (1) is an inner-rotor type interior magnet synchronous motor, and the rotor (12) has a permanent magnet (omitted from illustration) that generates a field magnetic flux.

The rotor (12) includes a rotor core (40) and the shaft (10) that is inserted into and fixed to the rotor core (40). The shaft (10) is rotatably attached to the casing (15) by the bearing (14). The shaft (10) is rotatably supported on the rotor core (40) only on one side of the axial direction (in this example, only a down side of the vertical direction).

A balance weight (13a) is provided on the compression mechanism (20) side of the rotor (12) in the direction of the shaft (10) (hereinafter “axial direction”). A balance weight (13c) is provided on the opposite side to the compression mechanism (20) of the rotor (12) in the axial direction. The centers of gravity of the balance weights (13a, 13c) are eccentric in the opposite directions from a shaft center (0). Each of the balance weights (13a, 13c) forms a weight.

For convenience of description of the structure, above the sectional view in FIG. 1, a top view of the rotor (12) (view of the rotor (12) seen from the opposite side to the compression mechanism (20) in the axial direction) is illustrated by being combined with the section of the rotor (12) by four imaginary lines, which are chain lines. Note that the structure of the electric motor (1) will be described later in detail.

Rotation of the rotor (12) (hereinafter also referred to as rotation of the electric motor (1)) causes centrifugal forces F_{A} and F_{C} to act on the balance weights (13a, 13c), respectively. Unbalanced magnetic pull F_{B} acts on the shaft (10). The unbalanced magnetic pull F_{B} is a component in a radial direction, i.e., a component in the direction orthogonal to the axial direction, attributed to an imbalance in magnetic pull between the stator (11) and the rotor (12). Only this component is focused herein because a deflection amount (hereinafter referred to as “axial deviation”) generated by the centrifugal forces F_{A} and F_{C} acting in the radial direction and also a stress applied in the radial direction on the shaft (10) is studied. For convenience, the unbalanced magnetic pull F_{B} is illustrated as acting at a position B of the shaft (10) in the center of the rotor (12) in the axial direction.

As the speed of rotation (hereinafter also referred to as “rotational speed”) of the motor (1) is higher, the centrifugal forces F_{A} and F_{C} are larger. As the rotational speed is higher, the axial deviation is larger. The axial deviation is a factor of a so-called uneven contact, which is an event in which a radial stress given from the shaft (10) to the bearing (14) becomes strong at a specific rotational angle.

In order to enhance the performance of the refrigeration circuit, the rotational speed is desirably high. In other words, a small axial deviation is advantageous in enhancing the performance of the refrigeration circuit.

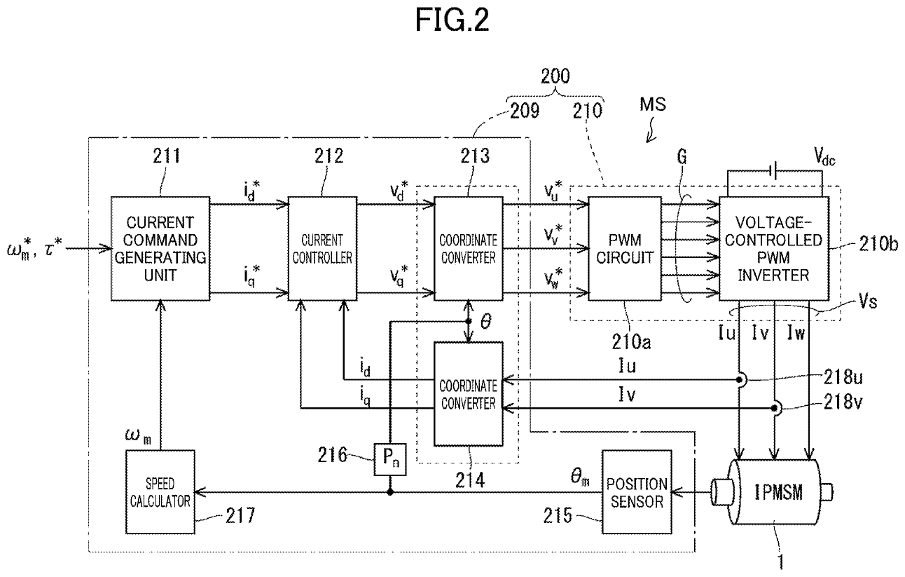

In the following embodiment, a motor driving technique for reducing the axial deviation is introduced. FIG. 2 is a block diagram illustrating a configuration of an electric motor system (MS). The electric motor system (MS) includes the electric motor (1) and a motor control apparatus (200) that drives the electric motor (1). Herein, an example of a case in which the electric motor (1) is a three-phase interior magnet synchronous motor (denoted as IPMSM in the figure) is illustrated. The motor control apparatus (200) converts three-phase alternating currents Iu, Iv, and Iw output to the electric motor (1) into a d-axis component (hereinafter “d-axis current”) i_{d} and a q-axis component (hereinafter “q-axis current”) i_{q} and performs vector control. The “d-axis” and “q-axis” herein indicate coordinate axes that advance in the same phase as the field magnetic flux of the electric motor (1) and 90 degrees with respect to this. The d-axis current i_{d} contributes to the field magnetic flux, and the q-axis current i_{q} contributes to a torque output from the electric motor (1).

The motor control apparatus (200) includes an output circuit (210) and a controller (209) that controls operation of the output circuit (210). The output circuit (210) outputs, to the electric motor (1), an application voltage |Vs| to be applied to the electric motor (1). The electric motor (1) is, for example, driven with the rotational speed controlled by the application voltage Vs. For example, the output circuit (210) performs DC/AC conversion on a direct-current voltage V_{dc} and outputs the three-phase application voltage Vs to the electric motor (1). The output circuit (210) supplies the three-phase alternating currents Iu, Iv, and Iw to the electric motor (1). The controller (209) constitutes a control unit.

The output circuit (210) includes a pulse-width modulation circuit (displayed as “PWM circuit” in the FIG. 210a) and a voltage-controlled PWM inverter (210b). The pulse-width modulation circuit (210a) receives three-phase voltage command values vᵤ*, vᵥ*, and v_{w}* and generates a gate signal G for controlling operation of the PWM inverter (210b). Note that an inverter of other modulation type may also be employed instead of the PWM inverter (210b). The PWM inverter (210b) constitutes an inverter.

The direct-current voltage V_{dc} is supplied to the PWM inverter (210b) from a direct-current power source. The PWM inverter (210b) performs operation controlled by the gate signal G, converts the direct-current voltage V_{dc} into the application voltage Vs, and applies it to the electric motor (1). The three-phase alternating currents Iu, Iv, and Iw are supplied from the PWM inverter (210b) to the motor (1). The voltage command values vᵤ*, vᵥ*, and v_{w}* are command values of the application voltage Vs.

Although the power source that supplies the direct-current voltage V_{dc} is provided outside the motor control apparatus (200) in FIG. 2, the power source may alternatively be included in the motor control apparatus (200). The power source can be, for example, an AC/DC converter.

The controller (209) includes, for example, a current command generating unit (211), a current controller (212), coordinate converters (213, 214), a position sensor (215), a multiplier (216), and a speed calculator (217).

Current sensors (218u, 218v) sense the alternating currents Iu and Iv, respectively. The controller (209) may alternatively include the current sensors (218u, 218v). The position sensor (215) senses the rotation position of the electric motor (1) as a rotational angle θₘ at the mechanical angle. The multiplier (216) multiplies the rotational angle θₘ by a number of pole pairs Pₙ to obtain a rotational angle θ as an electric angle. The coordinate converter (214) receives the values of the alternating currents Iu and Iv and the rotational angle θ and obtains the d-axis current i_{d} and the q-axis current i_{q}.

The speed calculator (217) obtains, from the rotational angle θₘ, a rotational speed ωₘ at a mechanical angle. The current command generating unit (211) receives a torque command T* or the rotational speed ωₘ and its command value ωᵢₙ*, and obtains, from these, a command value i_{d}* of the d-axis current i_{d} and a command value i_{q}* of the q-axis current i_{q}. The torque command T* is a command value of a torque T output from the electric motor (1).

From the d-axis current i_{d} and its command value i_{d}* and the q-axis current i_{q} and its command value i_{q}*, the current controller (212) obtains a command value v_{d}* of a d-axis voltage v_{d} and a command value v_{q}* of a q-axis voltage v_{q}. For example, the command values v_{d}* and v_{q}* can be obtained by feedback control for making the deviation between the d-axis current i_{d} and its command value i_{d}* and the deviation between the q-axis current i_{q} and its command value i_{q}* close to zero.

From the command value v_{d}* of the d-axis voltage v_{d}, the command value v_{q}* of the q-axis voltage v_{q}, and the rotational angle θ, the coordinate converter (213) generates the three-phase voltage command values vᵤ*, vᵥ*, and v_{w}*.

In this embodiment, the position sensor (215) is not necessarily provided. It is also possible to employ a so-called sensorless type in which the rotational angle θₘ is obtained from the alternating currents Iu and Iv and the application voltage Vs.

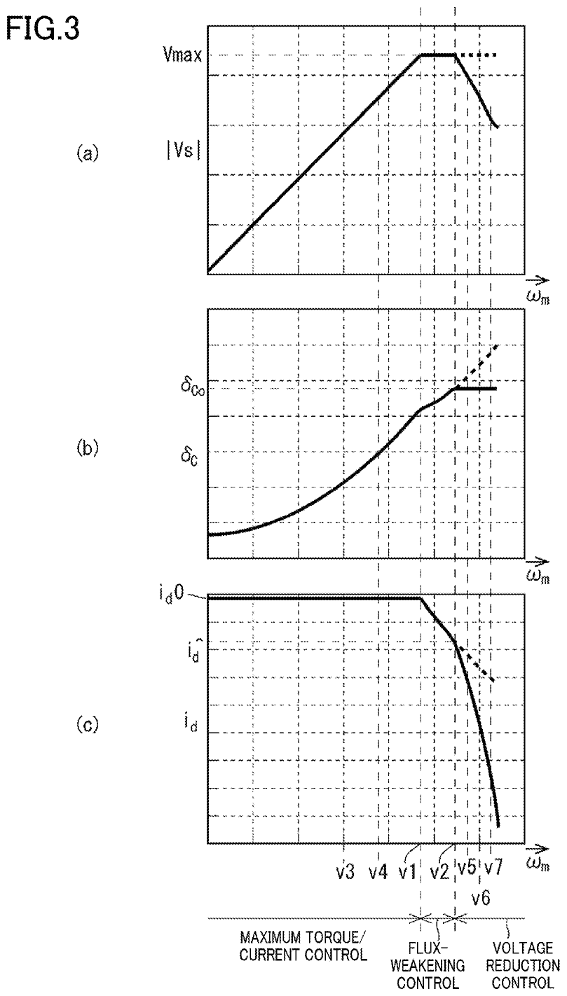

FIG. 3 is graphs illustrating relationships between control employed in this embodiment and the rotational speed ωₘ as solid lines. Each of parts (a), (b), and (c) in FIG. 3 employs the rotational speed ωₘ on the horizontal axis, and the torque command T* is fixed to a certain value.

Parts (a), (b), and (c) in FIG. 3 employ an amplitude |Vs| of the application voltage Vs on the vertical axis, an axial deviation δ_{C}, and the d-axis current i_{d} on the vertical axis, respectively. Herein, the axial deviation δ_{C} is an axial deviation at a position C (FIG. 1) on an end portion of the shaft (10) on the balance weight (13c) side in the axial direction.

When the rotational speed ωₘ is lower than or equal to a rotational speed v1 (also simply referred to as “speed v1”: the same applies to other rotational speeds), as the rotational speed ωₘ is higher, the amplitude |Vs| is larger. For example, as such control, maximum torque/current control or maximum efficiency control can be employed. FIG. 3 illustrates an example of a case in which the maximum torque/current control is performed when the rotational speed ωₘ is lower than or equal to the speed v1. In addition, the amplitude |Vs| when the rotational speed ωₘ is at the speed v1 is illustrated as a voltage value Vmax.

When the rotational speed ωₘ is higher than or equal to a speed v2, the amplitude |Vs| is less than the voltage value Vmax. The speed v2 is higher than or equal to the speed v1. Such control is provisionally called “voltage reduction control” for convenience in this embodiment. As its example, part (a) in FIG. 3 illustrates a case in which v2>v1 and the amplitude |Vs| is smaller as the rotational speed ωₘ is higher.

When the rotational speed ωₘ is higher than the speed v1 and lower than or equal to the speed v2, the amplitude |Vs| is equal to the amplitude |Vs|(=Vmax) at the speed v1 regardless of the rotational speed ωₘ. At this time, so-called flux-weakening control is performed on the electric motor (1). When v1=v2, a phenomenon in which the rotational speed ωₘ is higher than the speed v1 and lower than or equal to the speed v2 does not occur, and the flux-weakening control is not performed.

For dependency of the application voltage Vs on the rotational speed ωₘ, the controller (209) causes the output circuit (210) to output the application voltage Vs. Specifically, the controller (209) generates the voltage command values vᵤ*, vᵥ*, and v_{w}* by which the output circuit (210) outputs the application voltage Vs in accordance with the rotational speed ωₘ, and outputs these to the output circuit (210).

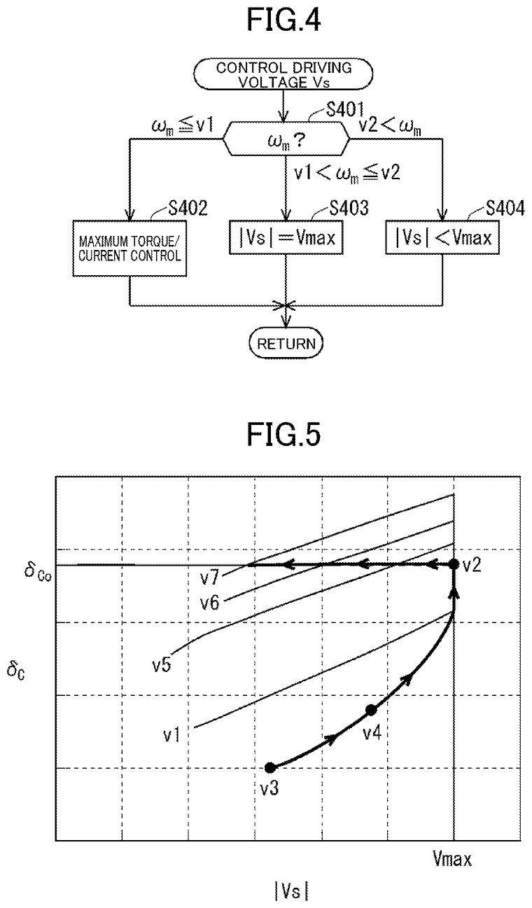

FIG. 4 is a flowchart illustrating control of the output circuit (210) by the controller (209). This flowchart is a routine for controlling the application voltage Vs. This routine is, for example, interrupt processing for a main routine that is not illustrated, which starts by interrupt processing and returns to the main routine upon ending of the routine. The routine is, for example, performed together with the main routine by the controller (209).

In step S401, the rotational speed ωₘ, the speed v1, and the speed v2 are compared. If it is determined in step S401 that ωₘ≤v1, the process proceeds to step S402. If it is determined in step S401 that v1<ωₘ≤v2, the process proceeds to step S403. If it is determined in step S401 that v2<ωₘ, the process proceeds to step S404.

In step S402, the maximum torque/current control is performed. Alternatively, instead of the maximum torque/current control, in step S402, the maximum efficiency control may be performed. Alternatively, in step S402, the maximum torque/current control and the maximum efficiency control may be performed by being switched therebetween.

In step S403, the voltage value Vmax is employed as the amplitude |Vs|, and, for example, the flux-weakening control is performed. In step S404, the voltage reduction control is performed, and a value less than the voltage value Vmax is employed as the amplitude |Vs|.

In FIG. 3, for comparison with this embodiment, the broken line represents a case in which the flux-weakening control is maintained without employing the “voltage reduction control” even if the rotational speed ωₘ is higher than the speed v2. In any case in which any of the maximum torque/current control, the maximum efficiency control, and the flux-weakening control is employed, as the rotational speed ωₘ is higher, the axial deviation δ_{C} is larger.

FIG. 3 illustrates an upper limit value δ_{Co} of the axial deviation δ_{C}. The speed v2 at which the axial deviation δ_{C} becomes the upper limit δ_{Co} by the maximum torque/current control, the maximum efficiency control, or the flux-weakening control is actually measured or calculated in advance. Herein, an example of a case is illustrated in which the rotational speed ωₘ is increased to exceed the speed v1, and even if the control is switched from the maximum torque/current control to the flux-weakening control, the axial deviation δ_{C} is less than the upper limit value δ_{Co} when the rotational speed ωₘ is lower than or equal to the speed v2. That is, an example of a case is illustrated in which, when the rotational speed ωₘ is lower than or equal to the speed v2, even if the amplitude |Vs| is maintained at the voltage value Vmax, the axial deviation δ_{C} is less than the upper limit value δ_{Co}.

When the rotational speed ωₘ exceeds the speed v2, the amplitude |Vs| becomes a value less than the voltage value Vmax. Thus, even if the rotational speed ωₘ is high, the axial deviation δ_{C} can be suppressed to be less than or equal to the upper limit value δ_{Co}.

For example, the voltage value Vmax is the maximum value of an alternating-current voltage into which the PWM inverter (210b) can convert the direct-current voltage V_{dc}. Since the maximum torque/current control is employed herein, the speed v1 at which the amplitude |Vs| becomes the voltage value Vmax corresponds with a base speed. The base speed herein is the maximum value of the rotational speed of the electric motor (1) at which the electric motor (1) can generate the torque T by the maximum torque/current control. In a case in which the maximum efficiency control is employed, the speed v1 is higher than the base speed.

FIG. 5 is a graph illustrating a relationship between the axial deviation δ_{C} and the amplitude |Vs| in which the rotational speed ωₘ is a parameter. FIGS. 3 and 5 illustrate cases in which the same torque command value τ* is used. Hereinafter, reasons why the axial deviation δ_{C} can be suppressed to be less than or equal to the upper limit value δ_{Co} by the voltage reduction control will be described with reference to FIG. 5.

FIG. 5 illustrates a relationship between the axial deviation δ_{C} and the amplitude |Vs| when the rotational speed ωₘ becomes a speed v1, v5, v6, or v7 (where v1<v2<v5<v6<v7). When the torque τ is maintained, as the amplitude |Vs| for achieving the rotational speed ωₘ is larger, the axial deviation δ_{C} is larger. As the rotational speed δₘ is higher, the axial deviation δ_{C} is larger.

In FIG. 5, when the rotational speed ωₘ becomes a speed v3, v4, or v2 (where v3<v4<v1<v2), the value of the axial deviation δ_{C} with the amplitude |Vs| employed during the maximum torque/current control and the flux-weakening control is additionally plotted. The thick line in FIG. 5 indicates that, in the direction of arrowheads attached thereto, the amplitude |Vs| employed in this embodiment changes in accordance with increase in the rotational speed ωₘ.

In accordance with increase in the rotational speed ωₘ to the speeds v3, v4, and v1, the amplitude |Vs| and the axial deviation δ_{C} increase. When the rotational speed ωₘ reaches the speed v1, the amplitude |Vs| reaches the voltage value Vmax. Thus, even if the rotational speed ωₘ is more increased, the amplitude |Vs| is no more increased.

Until the rotational speed ωₘ reaches the speed v2, the amplitude |Vs| is maintained at the voltage value Vmax (the thick-line arrow in FIG. 5 directs upward from bottom in parallel to the vertical axis). At this time, the flux-weakening control is performed, and the axial deviation δ_{C} increases.

When the rotational speed ωₘ reaches the speed v2, the axial deviation δ_{C} reaches the upper limit value δ_{Co} and when the rotational speed ωₘ exceeds the speed v2, the voltage reduction control is performed. Thus, even if the rotational speed ωₘ is high, the axial deviation δ_{C} is maintained at the upper limit value δ_{Co}.

It is needless to say that the axial deviation δ_{C} is not necessarily maintained at the upper limit value δ_{Co} even if the amplitude |Vs| is decreased. However, if the amplitude |Vs| is decreased to be less than the voltage value Vmax, the axial deviation δ_{C} is more reduced than that in a case in which the amplitude |Vs| is maintained at the voltage value Vmax. As for part (b) in FIG. 3, when the voltage reduction control is employed, the solid-line curve is always below the broken-line curve. In other words, the radial stress at a specific rotational angle when the electric motor (1) is rotating is reduced. This contributes to reduction of the uneven contact of the shaft (10) to the bearing (14).

As described above, the axial deviation δ_{C} may become less than the upper limit value δ_{Co} by decrease in the amplitude |Vs|. For example, the amplitude |Vs| in the voltage reduction control can be a fixed value that is lower than the voltage value represented by the solid line in part (a) in FIG. 3.

In part (c) in FIG. 3, also in the voltage reduction control as in the flux-weakening control, the d-axis current i_{d} decreases (since the d-axis current i_{d} is a negative value, the absolute value thereof increases). Note that the inclination of decrease in the d-axis current i_{d} with respect to increase in the rotational speed ωₘ is more obvious in the voltage reduction control than in the flux-weakening control.

Note that in the voltage reduction control, unlike in the simple flux-weakening control, the amplitude |Vs| becomes a value lower than the maximum thereof.

Hereinafter, the d-axis current i_{d} for making the axial deviation δ_{C} less than or equal to the upper limit value δ_{Co} will be described by using expressions.

TABLE 1

| Name | Symbol |
|---|---|
| d-axis permeance coefficient | P_{d0}, P_{d1} |
| q-axis permeance coefficient | P_{q0}, P_{q1} |
| d-axis gap permeance per unit area | p_{gd} = P_{d0} + 2P_{d1}COS(2Pₙθᵣₘ) |
| q-axis gap permeance per unit area | p_{gq} = P_{q0} + 2P_{q1}COS(2Pₙθᵣₘ) |
| permanent magnet magnetomotive force | F_{M} |
| constant | |
| armature current magnetomotive force | F_{D} |
| constant | |
| permanent magnet magnetomotive force | f_{M} = F_{M}cos(Pₙθᵣₘ) |
| armature current magnetomotive force | f_{D} = F_{D}(i_{d}cos[Pₙθᵣₘ] + i_{q}sin[Pₙθᵣₘ]) |
| number of pole pairs | Pₙ |
| arbitrary phase on rotor (based on d-axis, mechanical angle) | θᵣₘ |
| d-axis current | i_{d} |
| q-axis current | i_{q} |
| air permeability | μ₀ |
| offset amount of shaft 10 | x |
| average gap length between stator 11 and | g |
| rotor 12 | |
| unbalanced magnetic pull | F_{B} |
| centrifugal forces acting on balance | F_{A}, F_{C} |
| weights 13a and 13c | |
| axial deflection (axial stress) at point C | δ_{C} |
| axial stress predetermined value | δ_{Co} |
| constant determined by material physical | k_{A}, k_{B}, k_{C} |
| property and shape of shaft | |
| mass of balance weights 13a and 13c | m_{A}, m_{C} |
| center of gravity (rotation center | r_{A}, r_{C} |
| basis) of balance weights 13a and 13c | |
| mechanical angular speed | ωₘ |

The axial deviation δ_{C} can be expressed as Expression (1) based on an elasticity equation of beam deflection.

Math. 1

δ_{C}=k_{A}F_{A}+k_{B}F_{B}+k_{C}F_{C} (1)

As an armature winding included in the armature of the electric motor (1), a case in which a plurality of coils are connected in series for each phase is employed as an example. In this case, the unbalanced magnetic pull F_{B} is expressed as Expression (2).

$$\begin{matrix}Math . 2 & \\ {F}_{B} = \frac{x}{g} \cdot \frac{π}{2 {μ}_{0}} \cdot \{ \begin{matrix}{( {F}_{D} {i}_{d} + {F}_{M} )}^{2} [ {( {P}_{d 0} + {P}_{d 1} )}^{2} + {P}_{d 1}^{2} ] + \\ {( {F}_{D} {i}_{q} )}^{2} [ {( {P}_{q 0} - {P}_{q 1} )}^{2} + {P}_{q 1}^{2} ]\end{matrix} \} = {ai}_{d}^{2} + {bi}_{d} + c & ( 2 ) \\ where & \\ \{ \begin{matrix}a = \frac{x}{g} \cdot \frac{π}{2 {μ}_{0}} \cdot ( {F}_{D}^{2} ) [ {( {P}_{d 0} + {P}_{d 1} )}^{2} + {P}_{d 1}^{2} ] \\ b = \frac{x}{g} \cdot \frac{π}{2 {μ}_{0}} \cdot ( 2 {F}_{D} {F}_{M} ) [ {( {P}_{d 0} + {P}_{d 1} )}^{2} + {P}_{d 1}^{2} ] \\ c = \frac{x}{g} \cdot \frac{π}{2 {μ}_{0}} \cdot \{ \begin{matrix}+ ( {F}_{M}^{2} ) [ {( {P}_{d 0} + {P}_{d 1} )}^{2} + {P}_{d 1}^{2} ] \\ + {( {F}_{D} {i}_{q} )}^{2} [ {( {P}_{q 0} - {P}_{q 1} )}^{2} + {P}_{q 1}^{2} ]\end{matrix} \}\end{matrix} & \end{matrix}$$

The centrifugal forces F_{A} and F_{C} are expressed as Expression (3), and Expression (4) is derived from Expressions (1), (2), and (3).

$$\begin{matrix}Math . 3 & \\ {F}_{A} = {m}_{A} {r}_{A} {ω}_{m}^{2} , {F}_{C} = {m}_{C} {r}_{C} {ω}_{m}^{2} & ( 3 ) \\ Math . 4 & \\ {ω}_{m}^{2} = - \frac{{k}_{B} {δ}_{c}}{{k}_{A} {m}_{A} {r}_{A} + {k}_{C} {m}_{{C}^{{r}_{C}}}} ( a {i}_{d}^{2} + b {i}_{d} + c ) & ( 4 )\end{matrix}$$

In a case in which the q-axis current i_{q} is fixed, not only values a and b, but also a value c is fixed. Thus, from a relationship illustrated in Expression (5) obtained by setting δ_{C}=δ_{Co} in Expression (4), it is found that the square of the rotational speed ωₘ is in direct proportion to a quadratic expression of the d-axis current i_{d}. That is, by determining the d-axis current i_{d} in accordance with the rotational speed ωₘ according to Expression (5), the axial deviation δ_{C} can be less than or equal to the upper limit value δ_{Co}.

$$\begin{matrix}Math . 5 & \\ {ω}_{m}^{2} = - \frac{{k}_{B} {δ}_{co}}{{k}_{A} {m}_{A} {r}_{A} + {k}_{C} {m}_{C} {r}_{C}} ( a {i}_{d}^{2} + b {i}_{d} + c ) & ( 5 )\end{matrix}$$

As understood from Expression (5), when the d-axis current i_{d} is larger than the value (−b/2a), as the d-axis current i_{d} is smaller, the axial deviation δ_{C} is also smaller. When the d-axis current i_{d} is smaller than the value (−b/2a), as the d-axis current i_{d} is smaller, the axial deviation δ_{C} is larger. Thus, in order to reduce the axial deviation δ_{C} as much as possible, the d-axis current i_{d} is desirably the value (−b/2a).

FIG. 6 is a graph illustrating a relationship between a current amplitude iₐ (arbitrary unit) and the axial deviation δ_{C} in which the rotational speed ωₘ is a parameter. Note that the torque τ is fixed. Herein, iₐ=[i_{d}²+i_{q}²]^{1/2} and is the amplitude of a current vector Ia when the alternating currents Iu, Iv, and Iw are expressed as the current vector Ia.

FIG. 6 illustrates a relationship between the axial deviation δ_{C} and the current amplitude iₐ when the rotational speed ωₘ becomes a speed v1, v5, v6, or v7. When the torque τ is maintained, as the current amplitude iₐ for achieving the rotational speed ωₘ is larger, the axial deviation δ_{C} is smaller. As the rotational speed ωₘ is higher, the axial deviation δ_{C} is larger.

In FIG. 6, the value of the axial deviation δ_{C} (this corresponds to the upper limit value δ_{Co}) with the current amplitude iₐ employed during the flux-weakening control when the rotational speed ωₘ becomes a speed v2 is additionally plotted. At this time, the amplitude |Vs| becomes the voltage value Vmax, and the current amplitude iₐ becomes a value iₐ obtained as described later. When the rotational speed ωₘ is lower than or equal to the speed v1 during the maximum torque/current control, the current amplitude iₐ becomes a value iₐ0.

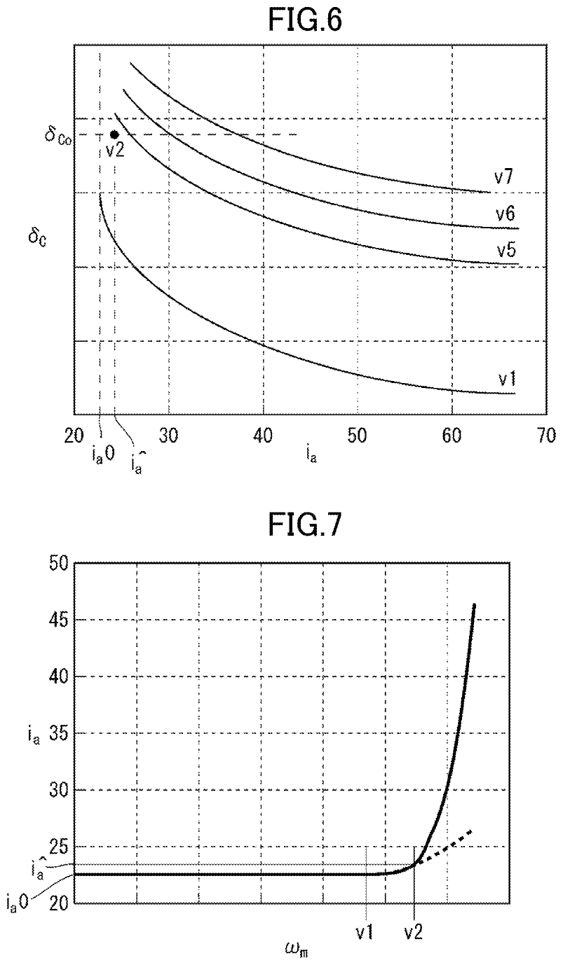

FIG. 7 is a graph illustrating a relationship between the rotational speed ωₘ and the current amplitude iₐ (arbitrary unit: the same unit as in FIG. 6) when the torque τ is a predetermined value. The solid line illustrates a case in which ωₘ>v2 and the voltage reduction control is employed, and the broken line illustrates a case in which ωₘ>v2 and the flux-weakening control is employed. In the illustrated cases, the maximum torque/current control is employed when ωₘ≤v1 and the flux-weakening control is employed when v1<ωₘ≤v2.

Thus, when the rotational speed ωₘ exceeds the speed v2, the current amplitude iₐ becomes a value larger than the value employed during the flux-weakening control (this is larger than the value iₐ\hat{ }), so that the above-described voltage reduction control can be performed.

That is, when the rotational speed ωₘ exceeds the speed v2, the controller (209) causes the output circuit (210) to output, to the electric motor (1), the alternating currents Iu, Iv, and Iw from which the current vector Ia with the current amplitude iₐ larger than the value of the current amplitude iₐ employed during the flux-weakening control (this is larger than the value iₐ\hat{ }) is obtained.

The value of the current amplitude iₐ employed during the flux-weakening control can be obtained as follows. Expressions (6), (7), (8), and (9) are satisfied by adopting a rotational speed ω as an electric angle, the torque τ (this may be substituted by the torque command value τ*), d-axis inductance Ld and q-axis inductance Lq of the electric motor (1), a field magnetic flux Ψ_{f}, generated by a permanent magnet of the field element included in the electric motor (1), an electric resistance Rₐ of the electric motor (1), the d-axis voltage v_{d} and the q-axis voltage v_{q} (these may be substituted by the respective command value v_{d}* and v_{q}*), and a differential operator p.

$$\begin{matrix}Math . 6 & \\ V max = \sqrt{{v}_{d}^{2} + {v}_{q}^{2}} & ( 6 ) \\ Math . 7 & \\ ( \begin{matrix}{v}_{d} \\ {v}_{q}\end{matrix} ) = ( \begin{matrix}{R}_{a} + {pL}_{d} & - ω {L}_{q} \\ ω {L}_{d} & {R}_{a} + {pL}_{q}\end{matrix} ) ( \begin{matrix}{i}_{d} \\ {i}_{q}\end{matrix} ) + ( \begin{matrix}0 \\ {ωΨ}_{a}\end{matrix} ) & ( 7 ) \\ Math . 8 & \\ τ = {P}_{n} {Ψ}_{a} {i}_{q} + {P}_{n} ( {L}_{d} - {L}_{q} ) {i}_{d} {i}_{q} & ( 8 ) \\ Math . 9 & \\ ia = \sqrt{{i}_{d}^{2} + {i}_{q}^{2}} & ( 9 )\end{matrix}$$

The rotational speed ω is obtained by the product of the rotational speed ωₘ and the number of pole pairs Pₙ. Thus, the current amplitude iₐ obtained from simultaneous equations of Expressions (6), (7), (8), and (9) where ω=Pₙ·ωₘ is the value of the current amplitude iₐ employed during the flux-weakening control. The current amplitude iₐ obtained from simultaneous equations of Expressions (6), (7), (8), and (9) in which the left side of Expression (6) is ω=Pₙ·v1 is the value iₐ0.

FIG. 8 is a graph illustrating a relationship between a phase β of the current vector Ia with respect to the q-axis and the axial deviation δ_{C} in which the rotational speed ωₘ is a parameter. Note that the torque τ is fixed. There is a relationship of Expression (10).

$$\begin{matrix}Math . 10 & \\ β = {tan}^{- 1} ( - \frac{{i}_{d}}{{i}_{q}} ) & ( 10 )\end{matrix}$$

FIG. 8 illustrates a relationship between the axial deviation δ_{C} and the phase β when the rotational speed ωₘ becomes a speed v1, v5, v6, or v7. When the torque τ is maintained, as the phase β for achieving the rotational speed ωₘ is larger, the axial deviation δ_{C} is smaller. As the rotational speed ωₘ is higher, the axial deviation δ_{C} is larger.

In FIG. 8, the value of the axial deviation δ_{C} (this corresponds to the upper limit value δ_{Co}) with the phase β employed during the flux-weakening control when the rotational speed ωₘ becomes a speed v2 is additionally plotted. At this time, the amplitude |Vs| becomes the voltage value Vmax, and the phase β becomes a value β\hat{ } obtained as described later. When the rotational speed ωₘ is lower than or equal to the speed v1 during the maximum torque/current control, the phase β becomes a value β0.

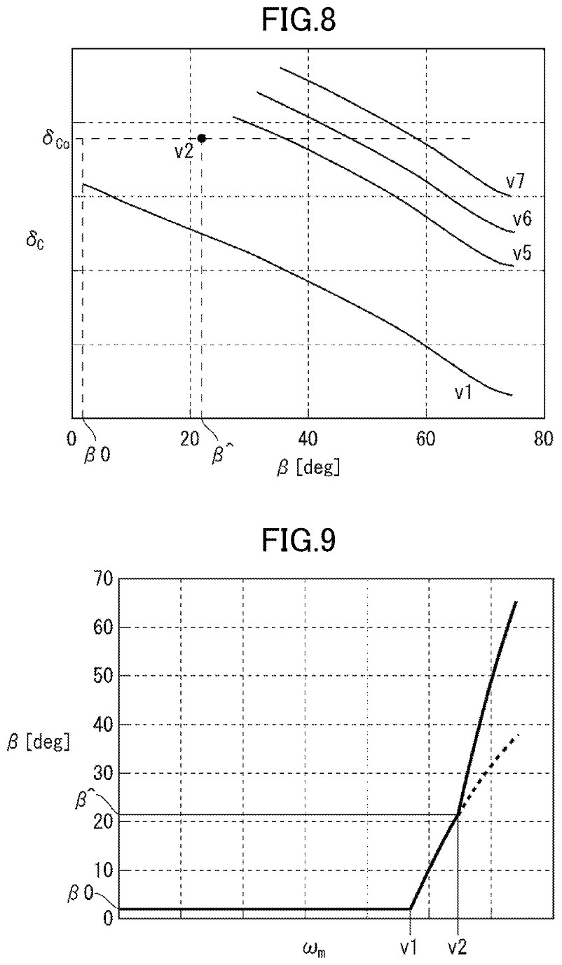

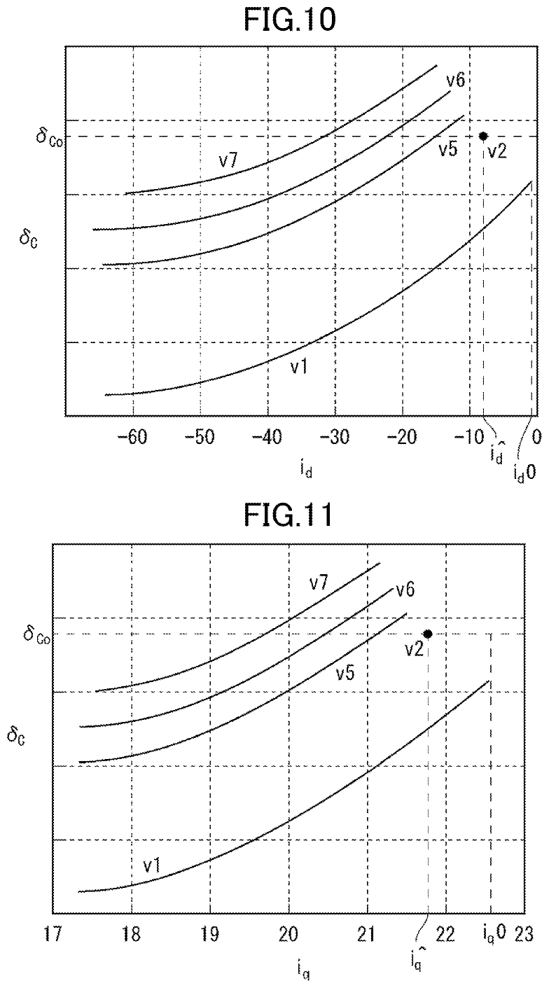

FIG. 9 is a graph illustrating a relationship between the rotational speed ωₘ and the phase β when the torque τ is a predetermined value. The solid line illustrates a case in which ωₘ>v2 and the voltage reduction control is employed, and the broken line illustrates a case in which ωₘ>v2 and the flux-weakening control is employed. In the illustrated cases, the maximum torque/current control is employed when ωₘ≤v1 and the flux-weakening control is employed when v1<ωₘ≤v2.

Thus, when the rotational speed ωₘ exceeds the speed v2, the phase β becomes a value larger than the value employed during the flux-weakening control (this is larger than the value β\hat{ }), so that the above-described voltage reduction control can be performed.

That is, when the rotational speed ωₘ exceeds the speed v2, the controller (209) causes the output circuit (210) to output, to the electric motor (1), the alternating currents Iu, Iv, and Iw with which the phase β larger than the value of the phase β employed during the flux-weakening control is obtained.

The phase β obtained from simultaneous equations of Expressions (6), (7), (8), and (10) where ω=Pₙ·ωₘ is the value of the phase β employed during the flux-weakening control. The phase β obtained from simultaneous equations of Expressions (6), (7), (8), and (10) in which the left side of Expression (6) is ω=Pₙ·v1 is the value β0.

FIG. 10 is a graph illustrating a relationship between the d-axis current i_{d} (<0; arbitrary unit) and the axial deviation δ₆ in which the rotational speed ωₘ is a parameter.

FIG. 10 illustrates a relationship between the axial deviation δ_{C} and the d-axis current i_{d} when the rotational speed ωₘ becomes a speed v1, v5, v6, or v7. Note that the torque τ is fixed. When the torque τ is maintained, as the d-axis current i_{d} for achieving the rotational speed ωₘ is larger (the absolute value is smaller), the axial deviation δ_{C} is larger. As the rotational speed ωₘ is higher, the axial deviation δ_{C} is larger.

In FIG. 10, the value of the axial deviation δ_{C} (this corresponds to the upper limit value δ_{Co}) with the d-axis current i_{d} employed during the flux-weakening control when the rotational speed ωₘ becomes a speed v2 is additionally plotted. At this time, the amplitude |Vs| becomes the voltage value Vmax, and the d-axis current i_{d} becomes a value i_{d}\hat{ } obtained as described later. When the rotational speed ωₘ is lower than or equal to the speed v1 during the maximum torque/current control, the d-axis current i_{d} becomes a value i_{d}0 (also refer to part (c) in FIG. 3).

Thus, when the rotational speed ωₘ exceeds the speed v2, the d-axis current i_{d} becomes a value smaller (the absolute value is larger) than a value employed during the flux-weakening control (this is smaller than the value i_{d}\hat{ }), so that the above-described voltage reduction control can be performed.

That is, when the rotational speed ωₘ exceeds the speed v2, the controller (209) causes the output circuit (210) to output, to the electric motor (1), the alternating currents Iu, Iv, and Iw having a d-axis component the value of which is smaller than the value of the d-axis current i_{d} employed during the flux-weakening control.

FIG. 11 is a graph illustrating a relationship between the q-axis current i_{q} (arbitrary unit) and the axial deviation δ_{C} in which the rotational speed ωₘ is a parameter. Note that the torque τ is fixed.

FIG. 11 illustrates a relationship with the axial deviation δ_{C} when the rotational speed ωₘ becomes a speed v1, v5, v6, or v7. When the torque τ is maintained, as the q-axis current i_{q} for achieving the rotational speed ωₘ is larger, the axial deviation δ_{C} is larger. As the rotational speed ωₘ is higher, the axial deviation δ_{C} is larger.

In FIG. 11, the value of the axial deviation δ_{C} (this corresponds to the upper limit value δ_{Co}) with the q-axis current iq employed during the flux-weakening control when the rotational speed ωₘ becomes a speed v2 is additionally plotted. At this time, the amplitude |Vs| becomes the voltage value Vmax, and the q-axis current i_{q} becomes a value i_{q}\hat{ } obtained as described later. When the rotational speed ωₘ is lower than or equal to the speed v1 during the maximum torque/current control, the q-axis current i_{q} becomes a value i_{q}0.

Thus, when the rotational speed ωₘ exceeds the speed v2, the q-axis current i_{q} becomes a value smaller than the value employed during the flux-weakening control (this is smaller than the value i_{q}\hat{ }), so that the above-described voltage reduction control can be performed.

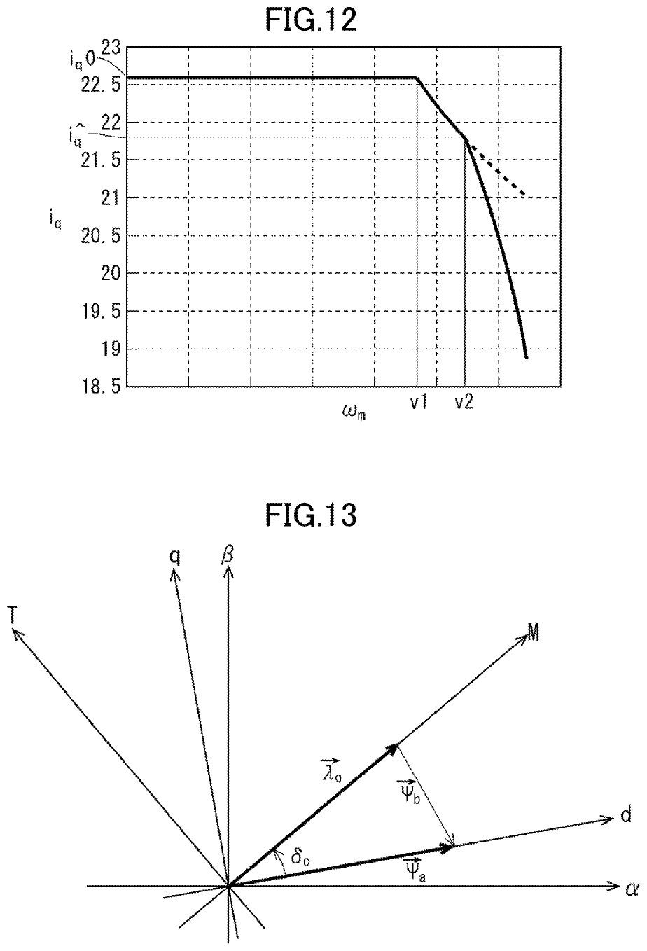

FIG. 12 is a graph illustrating a relationship between the rotational speed ωₘ and the q-axis current i_{q} (arbitrary unit: the same unit as in FIG. 11) when the torque τ is a predetermined value. The solid line illustrates a case in which ωₘ>v2 and the voltage reduction control is employed, and the broken line illustrates a case in which ωₘ>v2 and the flux-weakening control is employed. In the illustrated cases, the maximum torque/current control is employed when ωₘ≤v1 and the flux-weakening control is employed when v1<ωₘ≤v2.

That is, when the rotational speed ωₘ exceeds the speed v2, the controller (209) causes the output circuit (210) to output, to the electric motor (1), the alternating currents Iu, Iv, and Iw having a q-axis component the value of which is smaller than the value of the q-axis current i_{q} employed during the flux-weakening control.

The d-axis current i_{d} and the q-axis current i_{q} obtained from simultaneous equations of Expressions (6), (7), and (8) where ω=Pₙ·ωₘ are a d-axis current and a q-axis current, respectively, employed during the flux-weakening control. The d-axis current i_{d} and the q-axis current i_{q} obtained from simultaneous equations of Expressions (6), (7), and (8) in which the left side of Expression (6) is ω=Pₙ·v1 is the values i_{d}0 and i_{q}0.

FIG. 13 is a vector diagram illustrating a relationship between a field magnetic flux vector Ψₐ, a magnetic flux vector Ψ_{b} attributed to an armature reaction, and a primary magnetic flux vector λ₀. In FIG. 13, in order to explicitly indicate that these magnetic flux vectors Ψₐ, Ψ_{b}, and λ₀ are vectors, arrows are shown for the respective symbols. Note that, by using the same symbols, amplitudes of these vectors are also referred to as field magnetic flux Ψₐ, magnetic flux Ψ_{b}, and primary magnetic flux λ₀ in the description of this embodiment.

The primary magnetic flux vector λ₀ is a composite of a magnetic flux vector (−Ψ_{b}) and the field magnetic flux vector Ψₐ. A load angle δ₀ is a phase of the primary magnetic flux vector λ₀ with respect to the field magnetic flux vector Ψₐ. The primary magnetic flux λ₀ is represented as Expression (11). There is a relationship of Expression (12) between the primary magnetic flux λ₀ and the load angle δ₀.

$$\begin{matrix}Math . 11 & \\ {λ}_{o} = \sqrt{{( {Ψ}_{a} + {L}_{d} {i}_{d} )}^{2} + {( {L}_{q} {i}_{q} )}^{2}} & ( 11 ) \\ Math . 12 & \\ \{ \begin{matrix}{λ}_{o} cos {δ}_{o} = {L}_{d} {i}_{d} + {Ψ}_{a} \\ {λ}_{o} sin {δ}_{o} = {L}_{q} {i}_{q}\end{matrix} & ( 12 )\end{matrix}$$

An α axis and a β axis are coordinate axes of a fixed coordinate system in the electric motor (1). The d-axis and the q-axis are coordinate axes of a rotary coordinate system, meaning of each of which is described above. The field magnetic flux vector Ψₐ and the d-axis have the same phase and the same direction in a vector diagram. An M-axis and a T-axis indicate coordinate axes that advance in the same phase as the primary magnetic flux vector λ₀ and 90 degrees with respect to this, respectively. The primary magnetic flux vector λ₀ and the M-axis have the same direction in a vector diagram. Hereinafter, an M-axis component and a T-axis component of the three-phase alternating currents Iu, Iv, and Iw output to the electric motor (1) are also referred to as M-axis current i_{M} and T-axis current i_{T}. The T-axis current i_{T} is represented as Expression (13).

Math. 13

i_{T}=−i_{d} sin δₒ+i_{q} cos δₒ (13)

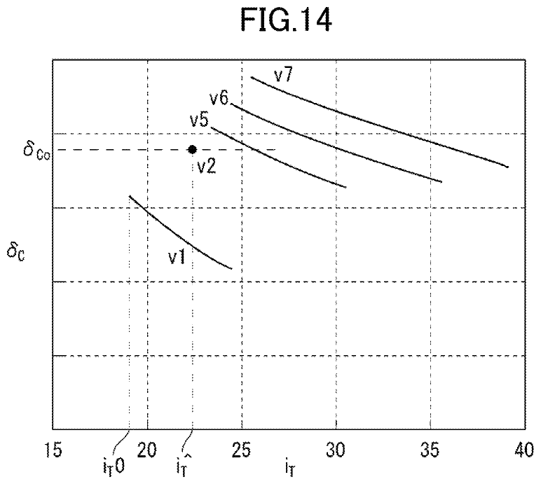

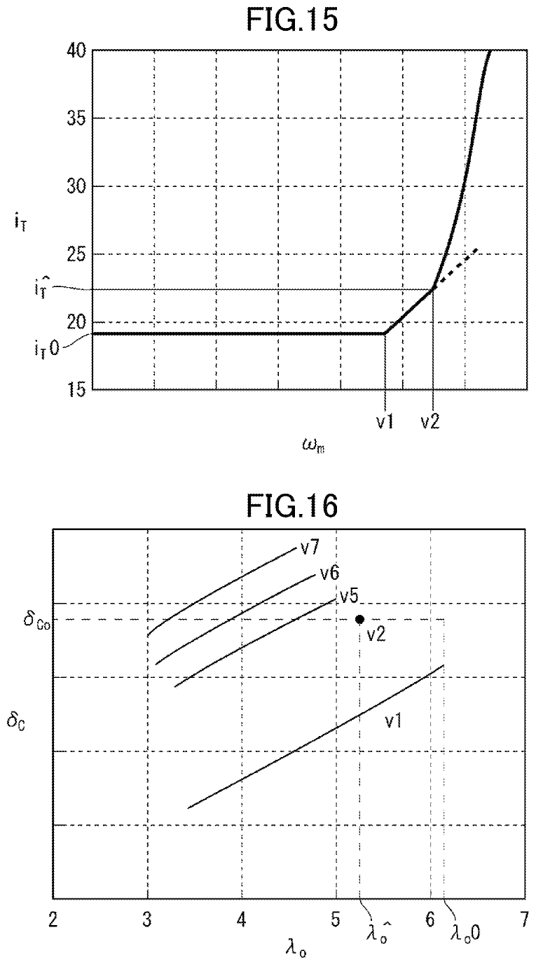

FIG. 14 is a graph illustrating a relationship between the T-axis current i_{T} (arbitrary unit) and the axial deviation δ₆ in which the rotational speed ωₘ is a parameter. Note that the torque τ is fixed.

FIG. 14 illustrates a relationship between the axial deviation δ_{C} and the T-axis current i_{T} when the rotational speed ωₘ becomes a speed v1, v5, v6, or v7. When the torque τ is maintained, as the T-axis current i_{T} for achieving the rotational speed ωₘ is larger, the axial deviation δc is smaller. As the rotational speed ωₘ is higher, the axial deviation δ_{C} is larger.

In FIG. 14, the value of the axial deviation δ_{C} (this corresponds to the upper limit value δ_{Co}) with the T-axis current i_{T} employed during the flux-weakening control when the rotational speed ωₘ becomes a speed v2 is additionally plotted. At this time, the amplitude |Vs| becomes the voltage value Vmax, and the T-axis current i_{T} becomes a value i_{T}\hat{ } obtained as described later. When the rotational speed ωₘ is lower than or equal to the speed v1 during the maximum torque/current control, the T-axis current i_{T} becomes a value i_{T}0.

Thus, when the rotational speed ωₘ exceeds the speed v2, the T-axis current i_{T} becomes a value larger than the value employed during the flux-weakening control (this is larger than the value i_{T}\hat{ }), so that the above-described voltage reduction control can be performed.

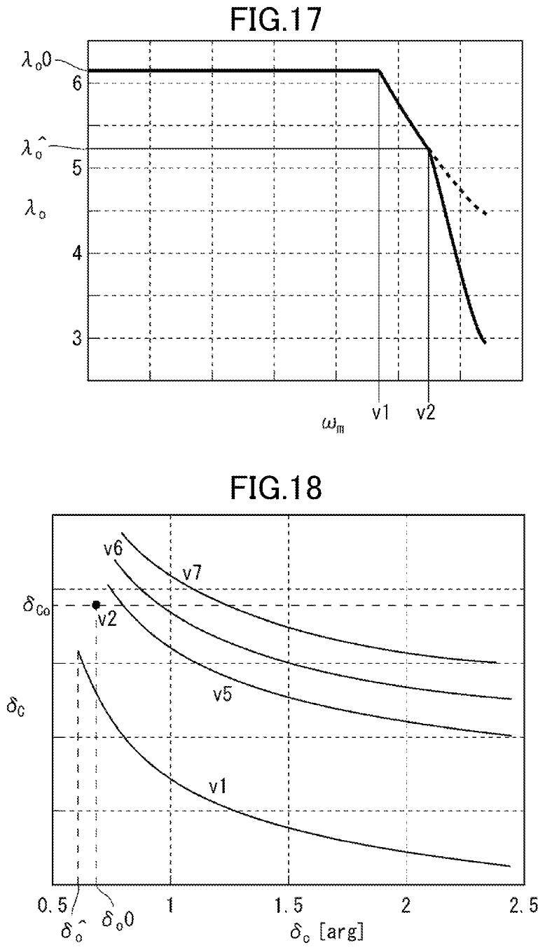

FIG. 15 is a graph illustrating a relationship between the rotational speed ωₘ and the T-axis current i_{T} (arbitrary unit: the same unit as in FIG. 14) when the torque τ is a predetermined value. The solid line illustrates a case in which ωₘ>v2 and the voltage reduction control is employed, and the broken line illustrates a case in which ωₘ>v2 and the flux-weakening control is employed. In the illustrated cases, the maximum torque/current control is employed when ωₘ≤v1 and the flux-weakening control is employed when v1<ωₘ≤v2.

That is, when the rotational speed ωₘ exceeds the speed v2, the controller (209) causes the output circuit (210) to output, to the electric motor (1), the alternating currents Iu, Iv, and Iw having a T-axis component the value of which is larger than the value of the T-axis component (T-axis current i_{T}) of the alternating currents Iu, Iv, and Iw output to the electric motor (1) in a case in which the flux-weakening control is performed at the speed.

The T-axis current i_{T} obtained from simultaneous equations of Expressions (6), (7), (8), (12), and (13) where ω=Pₙ·ωₘ is the value of the T-axis current i_{T} in a case in which the flux-weakening control is performed. The T-axis current i_{T} obtained from simultaneous equations of Expressions (6), (7), (8), (12), and (13) in which the left side of Expression (6) is ω=Pₙ·v1 is the value i_{T}0.

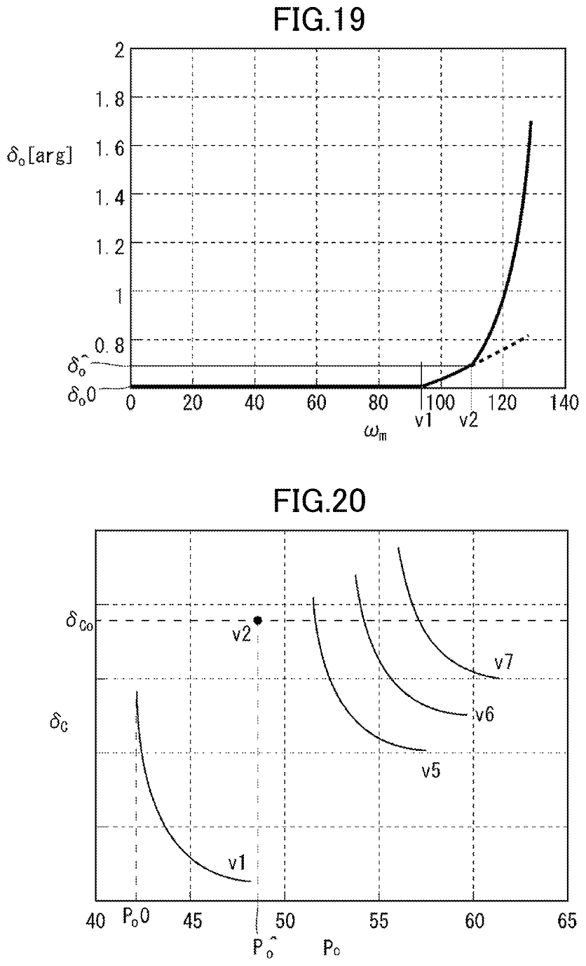

FIG. 16 is a graph illustrating a relationship between the primary magnetic flux λ₀ (arbitrary unit) and the axial deviation δ_{C} in which the rotational speed ωₘ is a parameter. Note that the torque τ is fixed.

FIG. 16 illustrates a relationship between the axial deviation δ_{C} and the primary magnetic flux λ₀ when the rotational speed ωₘ becomes a speed v1, v5, v6, or v7. When the torque τ is maintained, as the primary magnetic flux λ₀ for achieving the rotational speed ωₘ is larger, the axial deviation δ_{C} is larger. As the rotational speed ωₘ is higher, the axial deviation δ_{C} is larger.

In FIG. 16, the value of the axial deviation δ_{C} (this corresponds to the upper limit value δ_{Co}) with the primary magnetic flux λ₀ employed during the flux-weakening control when the rotational speed ωₘ becomes a speed v2 is additionally plotted. At this time, the amplitude |Vs| becomes the voltage value Vmax, and the primary magnetic flux λ₀ becomes a value λ₀\hat{ } obtained as described later. When the rotational speed ωₘ is lower than or equal to the speed v1 during the maximum torque/current control, the primary magnetic flux λ₀ becomes a value λ₀0.

Thus, when the rotational speed ωₘ exceeds the speed v2, the primary magnetic flux λ₀ having a value smaller than the value of the primary magnetic flux in a case in which the flux-weakening control is performed is generated, so that the above-described voltage reduction control can be performed.

FIG. 17 is a graph illustrating a relationship between the rotational speed ωₘ and the primary magnetic flux λ₀ (arbitrary unit: the same unit as in FIG. 16) when the torque τ is a predetermined value. The solid line illustrates a case in which ωₘ>v2 and the voltage reduction control is employed, and the broken line illustrates a case in which ωₘ>v2 and the flux-weakening control is employed. In the illustrated cases, the maximum torque/current control is employed when ωₘ≤v1 and the flux-weakening control is employed when v1<ωₘ≤v2.

That is, when the rotational speed ωₘ exceeds the speed v2, the controller (209) causes the output circuit (210) to output, to the electric motor (1), the alternating currents Iu, Iv, and Iw that causes the electric motor (1) to generate the primary magnetic flux λ₀ smaller than the value of the primary magnetic flux in a case in which the flux-weakening control is performed.

The primary magnetic flux λ₀ obtained from simultaneous equations of Expressions (6), (7), (8), and (11) where ω=Pₙ·ωₘ is the value of the primary magnetic flux λ₀ in a case in which the flux-weakening control is performed. The primary magnetic flux λ₀ obtained from simultaneous equations of Expressions (6), (7), (8), and (11) in which the left side of Expression (6) is ω=Pₙ·v1 is the value λ₀0.

FIG. 18 is a graph illustrating a relationship between the load angle δ₀ and the axial deviation δ_{C} in which the rotational speed ωₘ is a parameter. Note that the torque is fixed.

FIG. 18 illustrates a relationship between the axial deviation δ_{C} and the load angle δ₀ when the rotational speed ωₘ becomes a speed v1, v5, v6, or v7. When the torque τ is maintained, as the load angle δ₀ for achieving the rotational speed ωₘ is larger, the axial deviation δ_{C} is smaller. As the rotational speed ωₘ is higher, the axial deviation δ_{C} is larger.

In FIG. 18, the value of the axial deviation δ_{C} (this corresponds to the upper limit value δ_{Co}) with the load angle δₒ employed during the flux-weakening control when the rotational speed ωₘ becomes a speed v2 is additionally plotted. At this time, the amplitude |Vs| becomes the voltage value Vmax, and the load angle δ₀ becomes a value δ₀\hat{ } obtained as described later. When the rotational speed ωₘ is lower than or equal to the speed v1 during the maximum torque/current control, the load angle δ₀ becomes a value δ₀0.

Thus, when the rotational speed ωₘ exceeds the speed v2, the load angle δ₀ becomes a value larger than the value of the load angle in a case in which the flux-weakening control is performed, so that the above-described voltage reduction control can be performed.

FIG. 19 is a graph illustrating a relationship between the rotational speed ωₘ and the load angle δ₀ when the torque τ is a predetermined value. The solid line illustrates a case in which ωₘ>v2 and the voltage reduction control is employed, and the broken line illustrates a case in which ωₘ>v2 and the flux-weakening control is employed. In the illustrated cases, the maximum torque/current control is employed when ωₘ≤v1 and the flux-weakening control is employed when v1<ωₘ≤v2.

That is, when the rotational speed ωₘ exceeds the speed v2, the controller (209) causes the output circuit (210) to output the alternating currents Iu, Iv, and Iw that causes the electric motor (1) to generate the load angle δ₀ larger than the value of the load angle in a case in which the flux-weakening control is performed.

The load angle δ₀ obtained from simultaneous equations of Expressions (6), (7), (8), and (12) where ω=Pₙ·ωₘ is the value of the load angle δ₀ in a case in which the flux-weakening control is performed. The load angle δ₀ obtained from simultaneous equations of Expressions (6), (7), (8), and (12) in which the left side of Expression (6) is ω=Pₙ·v1 is the value δ₀0.

FIG. 20 is a graph illustrating a relationship between an instantaneous actual electric power Pₒ (arbitrary unit) and the axial deviation δ_{C} in which the rotational speed ωₘ is a parameter. Note that the torque is fixed.

FIG. 20 illustrates a relationship between the axial deviation δc and the instantaneous actual electric power P₀ when the rotational speed ωₘ becomes a speed v1, v5, v6, or v7. The instantaneous actual electric power P₀ is an instantaneous actual electric power supplied from the output circuit (210) to the electric motor (1). The instantaneous actual electric power Pₒ may be an instantaneous actual electric power generated by the electric motor (1). Pₒ=v_{d}·i_{d}+v_{q}·i_{q} and, for example, can be calculated by v_{d}*·i_{d}+v_{q}*·i_{q} by using the command values v_{d}* and v_{q}*.

When the torque τ is maintained, as the instantaneous actual electric power Pₒ for achieving the rotational speed ωₘ is larger, the axial deviation δ_{C} is smaller. As the rotational speed ωₘ is higher, the axial deviation δ_{C} is larger.

In FIG. 20, the value of the axial deviation δ_{C} (this corresponds to the upper limit value δ_{Co}) with the instantaneous actual electric power Pₒ employed during the flux-weakening control when the rotational speed ωₘ becomes a speed v2 is additionally plotted. At this time, the amplitude |Vs| becomes the voltage value Vmax, and the instantaneous actual electric power P₀ becomes a value Pₒ\hat{ } (=v_{d}*·i_{d}\hat{ }+v_{q}*·i_{q}\hat{ }). When the rotational speed ωₘ is lower than or equal to the speed v1 during the maximum torque/current control, the instantaneous actual electric power Pₒ becomes less than or equal to a value Pₒ0 (=v_{d}*·i_{d}0+v_{q}*·i_{q}0).

Thus, when the rotational speed ωₘ exceeds the speed v2, the instantaneous actual electric power P₀ becomes a value larger than the value of the instantaneous actual electric power in a case in which the flux-weakening control is performed, so that the above-described voltage reduction control can be performed.

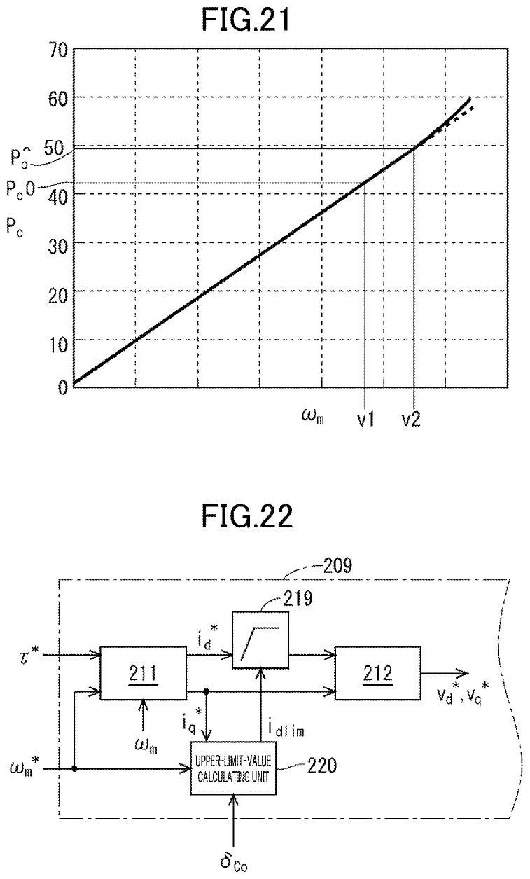

FIG. 21 is a graph illustrating a relationship between the rotational speed ωₘ and the instantaneous actual electric power Pₒ (arbitrary unit: the same unit as in FIG. 20) when the torque τ is a predetermined value. The solid line illustrates a case in which ωₘ>v2 and the voltage reduction control is employed, and the broken line illustrates a case in which ωₘ>v2 and the flux-weakening control is employed. In the illustrated cases, the maximum torque/current control is employed when ωₘ≤v1 and the flux-weakening control is employed when v1<ωₘ≤v2.

That is, when the rotational speed ωₘ exceeds the speed v2, the controller (209) causes the output circuit (210) to output, to the electric motor (1), the instantaneous actual electric power Pₒ larger than the value of the instantaneous actual electric power in a case in which the flux-weakening control is performed.

FIG. 22 is a block diagram illustrating a first modification of the controller (209). The first modification illustrates only an extracted periphery of the current command generating unit (211) and the current controller (212) illustrated in FIG. 2. In the first modification, a limiter (219) is provided between the current command generating unit (211) and the current controller (212) in the controller (209), and the command value i_{d}* of the d-axis current i_{d} is limited to less than or equal to an upper limit value i_{dlim}. Specifically, if the command value i_{d}* obtained from the current command generating unit (211) exceeds the upper limit value i_{dlim}, the limiter (219) inputs the upper limit value i_{dlim} as the command value i_{d}* to the current controller (212).

In the first modification, an upper-limit-value calculating unit (220) is further provided in the controller (209). The upper-limit-value calculating unit (220) calculates the upper limit value i_{dlim} by using the command value i_{q}* of the q-axis current i_{q}, the command value ωₘ* of the rotational speed ωₘ, and the upper limit value δ_{Co} of the axial deviation δ_{C}. Expression (5) can be modified into Expression (14).

$$\begin{matrix}Math . 14 & \\ {i}_{d} = \frac{- b + \sqrt{{b}^{2} - 4 a ( c + \frac{{ω}_{m}^{2} ( {k}_{A} {m}_{A} {r}_{A} + {k}_{C} {m}_{C} {r}_{C} )}{{k}_{B} {δ}_{co}} )}}{2 a} & ( 14 )\end{matrix}$$

In Expression (14), the upper limit value i_{dlim} can be calculated as the value of the d-axis current i_{d} obtained by employing the command value ωₘ* as the rotational speed ωₘ.

As described above, in order to reduce the axial deviation δ_{C} as much as possible, the d-axis current i_{d} is desirably the value (−b/2a). Thus, it is desirable not to satisfy i_{dlim}<(−b/2a). If i_{dlim}<(−b/2a), for example, control for reducing the command value ωₘ* (drop control) is desirably performed.

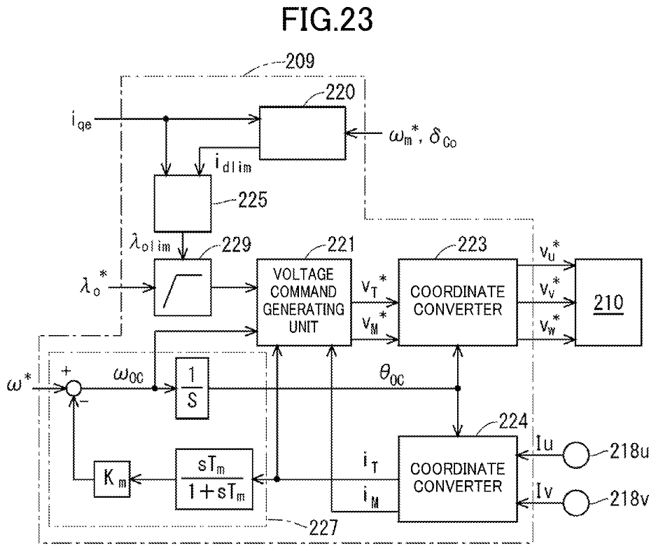

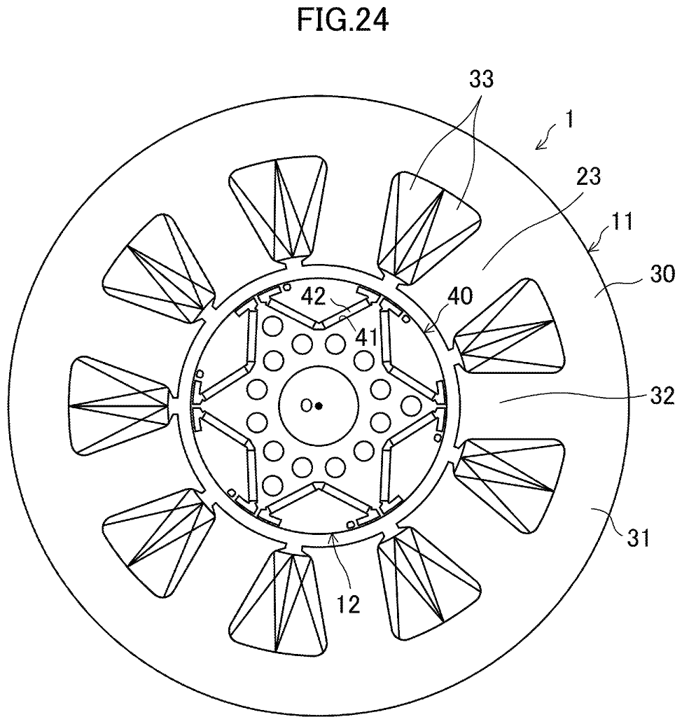

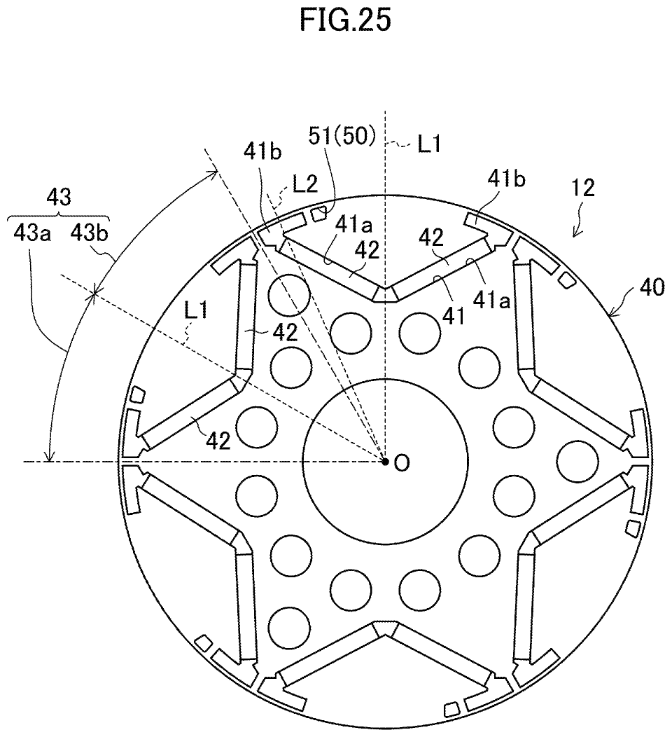

FIG. 23 is a block diagram illustrating a second modification of the controller (209). The second modification can be employed for so-called primary magnetic flux control in which the primary magnetic flux λ₀ is controlled.

The controller (209) includes, for example, a voltage command generating unit (221), coordinate converters (223, 224), and an angle calculating unit (227).

From a command value ω* of a rotational speed ω as an electric angle and the T-axis current i_{T}, by using a known method, the angle calculating unit (227) obtains a rotational speed ω_{OC} of the M-axis and further obtains a position θ_{OC} of the M-axis. From the values of the alternating currents Iu and Iv and the position θ_{OC}, the coordinate converter (224) obtains the M-axis current i_{M} and the T-axis current i_{T}.

The voltage command generating unit (221) obtains the M-axis current i_{M}, the T-axis current i_{T}, and a command value λ₀ of the primary magnetic flux and, from the rotational speed ω_{OC}, a command value v_{T}* of a T-axis voltage v_{T} and a command value v_{M}* of an M-axis voltage v_{M}.

From the command values v_{T}* and v_{M}* and the position θ_{OC}, the coordinate converter (223) generates the three-phase voltage command values vᵤ*, vᵥ*, and v_{w}*.

The controller (209) further includes a limiter (229), the upper-limit-value calculating unit (220), and an upper-limit-value calculating unit (225). The limiter (229) limits the command value IN of the primary magnetic flux λ₀ to less than or equal to an upper limit value λ₀ₗᵢₘ. Specifically, if the command value λ₀* exceeds the upper limit value λ₀₁ᵢₘ, the limiter (229) inputs the upper limit value λ₀ₗᵢₘ as the command value λ₀* to the voltage command generating unit (221).

The upper-limit-value calculating unit (220) can calculate the upper limit value i_{dlim} as the value of the d-axis current i_{d} obtained by employing the command value ωₘ* as the rotational speed ωₘ and an estimated value i_{qe} as the q-axis current i_{q} in Expression (14).

The upper-limit-value calculating unit (225) can calculate the upper limit value λ₀ₗᵢₘ as the value of the primary magnetic flux λ₀ obtained by employing i_{d}=i_{dlim} and i_{q}=i_{qe} in Expression (11).

Expression (12) can be modified into Expression (15). From Expressions (4) and (15), Expression (16) can be obtained. From Expression (16), if the load angle δ₀ and the axial deviation δ_{C} are fixed, it is found that the square of the rotational speed ωₘ is in direct proportion to a quadratic expression of the primary magnetic flux λ₀.

$$\begin{matrix}Math . 15 & \\ \{ \begin{matrix}{i}_{d} = \frac{{λ}_{o} cos {δ}_{o} - {Ψ}_{a}}{{L}_{d}} \\ {i}_{q} = \frac{{λ}_{o} sin {δ}_{o}}{{L}_{q}}\end{matrix} & ( 15 ) \\ Math . 16 & \\ {ω}_{m}^{2} = - \frac{{k}_{B} {δ}_{co}}{{k}_{A} {m}_{A} {r}_{A} + {k}_{C} {m}_{C} {r}_{C}} ( a {\{ \frac{{λ}_{o} cos {δ}_{o} - {Ψ}_{a}}{{L}_{d}} \}}^{2} + b \{ \frac{{λ}_{o} cos {δ}_{o} - {Ψ}_{a}}{{L}_{d}} \} + \frac{x}{g} \cdot \frac{π}{2 {μ}_{0}} \cdot \{ \begin{matrix}+ ( {F}_{M}^{2} ) [ {( {P}_{d 0} + {P}_{d 1} )}^{2} + {P}_{d 1}^{2} ] \\ + {( {F}_{D} \frac{{λ}_{o} sin {δ}_{o}}{{L}_{q}} )}^{2} [ {( {P}_{q 0} - {P}_{q 1} )}^{2} + {P}_{q 1}^{2} ]\end{matrix} \} ) = - \frac{{k}_{B} {δ}_{co}}{{k}_{A} {m}_{A} {r}_{A} + {k}_{C} {m}_{C} {r}_{C}} ( a {\{ \frac{{λ}_{o} cos {δ}_{o} - {Ψ}_{a}}{{L}_{d}} \}}^{2} + b \{ \frac{{λ}_{o} cos {δ}_{o} - {Ψ}_{a}}{{L}_{d}} \} + d + e {\{ \frac{{λ}_{o} sin {δ}_{o}}{{L}_{q}} \}}^{2} ) = - \frac{{k}_{B} {δ}_{c}}{{k}_{A} {m}_{A} {r}_{A} + {k}_{C} {m}_{C} {r}_{C}} \{ ( \frac{a {cos}^{2} {δ}_{o}}{{L}_{d}^{2}} + \frac{e {sin}^{2} {δ}_{o}}{{L}_{q}^{2}} ) {λ}_{o}^{2} + ( - \frac{a 2 cos {δ}_{o} {Ψ}_{a}}{{L}_{d}^{2}} + \frac{b cos {δ}_{o}}{{L}_{d}} ) {λ}_{o} + ( \frac{a {Ψ}_{a}^{2}}{{L}_{d}^{2}} - \frac{b {Ψ}_{a}}{{L}_{d}} + d ) \} & ( 16 ) \\ where & \\ \{ \begin{matrix}d = \frac{x}{g} \cdot \frac{π}{2 {μ}_{0}} ( {F}_{M}^{2} ) [ {( {P}_{d 0} + {P}_{d 1} )}^{2} + {P}_{d 1}^{2} ] \\ e = \frac{x}{g} \cdot \frac{π}{2 {μ}_{0}} {( {F}_{D} )}^{2} [ {( {P}_{q 0} - {P}_{q 1} )}^{2} + {P}_{q 1}^{2} ]\end{matrix} & \end{matrix}$$

The upper limit value λ₀ₗᵢₘ may also be obtained according to Expression (16) in which δ_{C}=δ_{Co} and ωₘ=ωₘ*.

As described above, the motor control apparatus (200) includes the PWM inverter (210b) and the controller (209). The PWM inverter (210b) outputs, to the electric motor (1), the application voltage Vs to be applied to the electric motor (1). The controller (209) controls operation of the PWM inverter (210b). The electric motor (1) drives the compression mechanism (20), which is the load, by using rotation of the shaft (10). The PWM inverter (210b) is included in the output circuit (210).

In the above-described embodiment, for example, in a case in which the predetermined torque τ is caused to be output from the electric motor (1),

(i) when the rotational speed ωₘ is lower than or equal to the speed v1, as the rotational speed ωₘ is higher, the amplitude |Vs| is larger (e.g., the maximum torque/current control or the maximum efficiency control); (ii) the amplitude |Vs| when the rotational speed ωₘ is higher than the speed v2 (≥v1) is less than the voltage value Vmax of the amplitude |Vs| at the speed v1 (the voltage reduction control); and (iii) the amplitude |Vs| when the rotational speed ωₘ is higher than the speed v1 and lower than or equal to the speed v2 is the voltage value Vmax (e.g., the flux-weakening control).

For example, during the voltage reduction control, when the rotational speed ωₘ is higher than the speed v2, as the rotational speed ωₘ is higher, the amplitude |Vs| is smaller.

In a case in which the electric motor (1) is caused to generate the predetermined torque τ, when the rotational speed ωₘ exceeds the speed v2, the controller (209) causes the PWM inverter (210b) to, for example:

(iia) output, to the electric motor (1), the alternating currents Iu, Iv, and Iw with the phase β larger than the phase β of the alternating currents Iu, Iv, and Iw output to the electric motor (1) when the flux-weakening control is applied at the speed;

(iib) output, to the electric motor (1), the alternating currents Iu, Iv, and Iw from which the current vector Ia with the current amplitude iₐ larger than the current amplitude iₐ of the current vector Ia of the alternating currents Iu, Iv, and Iw output to the electric motor (1) when the flux-weakening control is applied at the speed can be obtained;

(iic) output, to the electric motor (1), the alternating currents Iu, Iv, and Iw having a d-axis component (d-axis current i_{d}) smaller than the d-axis component (value i₄ of the d-axis current i_{d}) of the alternating currents Iu, Iv, and Iw output to the electric motor (1) when the flux-weakening control is applied at the speed;

(iid) output, to the electric motor (1), the alternating currents Iu, Iv, and Iw having a q-axis component (q-axis current i_{q}) smaller than the q-axis component (value i_{q} of the q-axis current i_{q}) of the alternating currents Iu, Iv, and Iw output to the electric motor (1) when the flux-weakening control is applied at the speed;

(iie) output, to the electric motor (1), the alternating currents Iu, Iv, and Iw having a T-axis component (T-axis current i_{T}) larger than the T-axis component (value i_{T} of the T-axis current i_{T}) of the alternating currents Iu, Iv, and Iw output to the electric motor (1) when the flux-weakening control is applied at the speed;

(iif) output, to the electric motor (1), the alternating currents Iu, Iv, and Iw that causes the electric motor (1) to generate the primary magnetic flux k₀ with an amplitude smaller than the primary magnetic flux (more strictly, the value λ₀ of the amplitude) generated in the electric motor (1) when the flux-weakening control is applied at the speed;

(iig) output, to the electric motor (1), the alternating currents Iu, Iv, and Iw that causes the electric motor (1) to generate the primary magnetic flux k₀ with a load angle δ₀ larger than the load angle δ₀ of the primary magnetic flux λ₀ generated in the electric motor (1) when the flux-weakening control is applied at the speed; or

(iih) output, to the electric motor (1), the instantaneous actual electric power P₀ larger than the instantaneous actual electric power P₀ generated in the electric motor (1) when the flux-weakening control is applied at the speed.

It is not always necessary to employ the maximum torque/current control, the maximum efficiency control, or the flux-weakening control. Typically, the maximum rotational speed of a motor employed in a product system is determined depending on the product system. The product system herein includes, in terms of the embodiment, the electric motor (1), the motor control apparatus (200), and the compression mechanism (20) driven by the electric motor (1). The maximum amplitude |Vs| depends on the rotational speed ωₘ.

For convenience of the following description, various quantities are defined. The maximum rotational speed ωₘ of the electric motor (1) determined depending on the product system is a speed ω_{MAX}. A possible maximum amplitude |Vs| when the electric motor (1) rotates at the speed ω_{MAX} is a voltage value V_{max_}ω_{MAX}. A possible maximum amplitude |Vs| when the electric motor (1) rotates at a speed ω3 lower than the speed ω_{MAX} is a voltage value V_{max_}ω3.

As described above, as the rotational speed is higher, the axial deviation δ_{C} is larger. The axial deviation δ_{C} can be decreased by decreasing the amplitude |Vs|. Thus, when the electric motor (1) rotates at the speed δ_{MAX}, the PWM inverter (210b) desirably outputs the application voltage Vs smaller than the voltage value V_{max_}ω_{MAX}.

On the other hand, in order to reduce current to be consumed, the amplitude |Vs| desirably becomes the possible maximum when the electric motor (1) rotates. Thus, at the at least one speed ω3, the PWM inverter (210b) desirably outputs the application voltage Vs with the amplitude |Vs| of the voltage value V_{max_}ω3.

These can be summarized and expressed as follows:

(a) the PWM inverter (210b) is caused to output the application voltage Vs having the amplitude |Vs| smaller than the voltage value V_{max_}ω_{M}Ax, and the electric motor (1) is caused to rotate at the speed δ_{MAX} and drive a load (e.g., the compression mechanism (20)); and

(b) the PWM inverter (210b) is caused to output the application voltage Vs having the amplitude |Vs| of the voltage value V_{max_}ω3, and the electric motor (1) is caused to rotate at the speed ω3 (<ω_{MAX}) and drive the load; in which

(c) the voltage value V_{max_}ω_{M}Ax is a possible maximum value of the amplitude |Vs| when the electric motor (1) drives the load at the speed δ_{MAX};

(d) the speed ω_{MAX} is a maximum of the rotational speed ωₘ when the electric motor (1) drives the load;

(e) the voltage value V_{max_}ω3 is a possible maximum value of the amplitude |Vs| when the electric motor (1) drives the load at the speed ω3; and

(f) the speed ω3 is lower than the speed ω_{MAX} (the above conditions are not necessarily satisfied at all rotational speeds ωₘ smaller than the speed ω_{MAX}).

In other words:

(g) at the speed δ_{MAX}, the ratio of the amplitude |Vs| to the voltage value V_{max_}ω_{MAX} is smaller than 1; and

(h) at the certain speed ω3 lower than the speed δ_{MAX}, the ratio of the amplitude |Vs| to the voltage value V_{max_}ω3 is equal to 1.

Without limitation to when the electric motor (1) rotates at the speed ω_{MAX}, as the rotational speed ωₘ is higher, the axial deviation δ_{C} is larger. In addition, the voltage reduction control is performed at the rotational speed ωₘ higher than or equal to the base speed (defined as a maximum rotational speed of the electric motor (1) at which the electric motor (1) can generate the torque τ during the maximum torque/current control or the maximum efficiency control). Thus, by adopting the base speed ωb when the electric motor (1) outputs the predetermined torque τ, the speeds ω1 (≥ωb) and ω2 (>ω1), the voltage value V_{max_}ω1 as the possible maximum of the amplitude |Vs| at rotation at the speed ω1, and the voltage value V_{max_}ω2 as the possible maximum of the amplitude |Vs| at rotation at the speed ω2, there may be a relationship as follows.

When the electric motor (1) outputs the predetermined torque τ,

(i) the ratio of the amplitude |Vs| to the voltage value V_{max_}ω1 at the certain speed ω1, which is higher than or equal to the base speed cob when the predetermined torque τ is output is a first ratio;

(j) the ratio of the amplitude |Vs| to the voltage value V_{max_}ω2 at the certain speed ω2 higher than the speed ω1 is a second ratio; and

(k) the second ratio is smaller than the first ratio (the above conditions are not necessarily satisfied at all of two rotational speeds ωₘ higher than or equal to the base speed ωb).

In other words, in a case in which the rotational speed ωₘ when the electric motor (1) outputs the predetermined torque τ is higher than or equal to the base speed cob when the predetermined torque τ is output:

(l) the PWM inverter (210b) is caused to output the application voltage Vs having the amplitude |Vs| obtained by multiplying the voltage value V_{max_}ω1 by the first ratio, the electric motor (1) is caused to rotate at the speed ω1, and the electric motor (1) is caused to output the torque τ;

(m) the PWM inverter (210b) is caused to output the application voltage Vs having the amplitude |Vs| obtained by multiplying the voltage value V_{max_}ω2 by the second ratio, the electric motor (1) is caused to rotate at the speed ω2, and the electric motor (1) is caused to output the torque τ;

(n) the voltage value V_{max_}ω1 is a possible maximum value of the amplitude |Vs| when the electric motor (1) outputs the torque τ at the speed ω1;

(o) the voltage value V_{max_}ω2 is a possible maximum value of the amplitude |Vs| when the electric motor (1) outputs the torque τ at the speed ω2;

(p) the speed ω2 is higher than the speed ω1; and

(q) the second ratio is smaller than the first ratio.

For the relationship ω2>ω1≥ωb, the speed ω2 may be a possible maximum ωₘₐₓ of the rotational speed ωₘ when the electric motor (1) outputs the torque τ. When ω1=v1, Vmax=V_{max_}ω1 is satisfied.

A case in which v2>ωb and the torque τ is maintained is described with reference to FIG. 3 as an example. As described above, v6>v5>v2 is satisfied.

(l′) The electric motor (1) is caused to rotate at the speed v5, and the amplitude |Vs| at this time has a value obtained by multiplying the first voltage value by the first ratio;

(m′) the electric motor (1) is caused to rotate at the speed v6, and the amplitude |Vs| at this time has a value obtained by multiplying the second voltage value by the second ratio;

(n′) the first voltage value is the possible maximum value of the amplitude |Vs| when the electric motor (1) outputs the torque τ at the speed v5;

(o′) the second voltage value is the possible maximum value of the amplitude |Vs| when the electric motor (1) outputs the torque τ at the speed v6;

(p′) the speed v6 is higher than the speed v5; and

(q′) the second ratio is smaller than the first ratio.

By the above-described control, the radial stress at a specific rotational angle when the electric motor (1) is rotating is reduced. This contributes to reduction of the uneven contact of the shaft (10) to the bearing (14).

Although the power source that supplies the direct-current voltage V_{dc} is provided outside the motor control apparatus (200), the power source may alternatively be included in the motor control apparatus (200). The power source can be, for example, an AC/DC converter. The amplitude |Vs| of the application voltage Vs output from the PWM inverter (210b) in such a case will be described below.

The converter converts an alternating-current voltage Vin into the direct-current voltage V_{dc}. In this conversion, an alternating current Iin flows into the converter and a direct current Idc is output. A power factor cos Φin on the input side of the converter and a loss Ploss1 at the time of conversion of the converter are adopted.

In the following description, the PWM inverter (210b) outputs an alternating-current voltage Vout and an alternating current Iout. A power factor cos Φout on the output side of the PWM inverter (210b) and a loss Ploss2 at the time of conversion of the PWM inverter (210b) are adopted.

Regarding the converter, the following Expression (17) is satisfied based on the law of the conservation of energy. In the first expression, the second term on the right side indicates voltage drop attributed to the converter loss. A transformer ratio a of the converter is adopted.

Math. 17

Vdc=Vin×a−Ploss1/Idc, a=Iin×cos Φin/Idc (17)

Regarding the PWM inverter (210b), the following Expression (18) is satisfied based on the law of the conservation of energy. In the first expression, the second term on the right side indicates voltage drop attributed to the converter loss. A percent modulation b of the PWM inverter (210b) is adopted.

Math. 18

Vout=Vdc×b−Ploss2/(Iout×cos Φout), b=Idc/Iout/cos Φout (18)

From Expressions (17) and (18), the following expression is satisfied.

$$\begin{matrix}Math . 19 & \\ \begin{matrix}Vout = ( Vin \times a - Ploss 1 / Idc ) \times b - Ploss 2 / ( Iout \times cos Φ out ) \\ = Vin \times a \times b - b \times Ploss 1 / Idc - Ploss 2 / ( Iout \times cos Φ out )\end{matrix} & ( 19\end{matrix}$$

From Expression (19), the alternating-current voltage Vout output from the PWM inverter (210b) is uniquely determined by the alternating-current voltage Vin converted by the converter, the transformer ratio a, the percent modulation b, the loss Ploss1 of the converter, the loss Ploss2 of the PWM inverter (210b), the direct current Idc input to the PWM inverter (210b), the alternating current Iout output from the PWM inverter (210b), and the power factor cos Φout of the PWM inverter (210b). Note that the transformer ratio a, the percent modulation b, the losses Ploss1 and Ploss2, the direct current Idc, the alternating current Iout, and the power factor cos Φout are uniquely determined if the product system that employs the motor to which voltage is applied from the PWM inverter (210b), and the torque and rotational speed of the motor are determined.

Thus, the amplitude |Vs| in the above embodiment is uniquely determined if the power source voltage, the product system, the torque τ, and the rotational speed ωₘ are determined. However, in a case in which the power source that supplies the direct-current voltage V_{dc} is an AC/DC converter, the amplitude |Vs| is also dependent on the alternating-current voltage Vin input to the converter.

The maximum of the amplitude |Vs| is further described. From Expression (19), the alternating-current voltage Vout becomes a maximum when the transformer ratio a and the percent modulation b are maximums. When maximums aMAX and bMAX of the transformer ratio a and the percent modulation b, respectively, are adopted, a maximum VoutMAX of the alternating-current voltage Vout is determined according to the following Expression (20).

Math. 20

VoutMAX=Vin×aMAX×bMAX−bMAX×Ploss1/Idc−Ploss2/(Iout×cos Φout) (20)

The maximums aMAX and bMAX are each uniquely determined according to product system. As described above, the amplitude |Vs| is uniquely determined if the power source voltage, the product system, the torque τ, and the rotational speed ωₘ are determined. Thus, the maximum of the amplitude |Vs| is also uniquely determined if the power source voltage, the product system, the torque τ, and the rotational speed ωₘ are determined. For example, when the same torque τ is maintained in a certain product system at a certain power source voltage, the voltage values V_{max_}ω1, V_{max_}ω2, V_{max_}ω3, and V_{max_}ω_{MAX} are uniquely determined by the speeds ω1, ω2, ω3, and ω_{MAX}, respectively.

However, in a case in which the power source that supplies the direct-current voltage V_{dc} is an AC/DC converter, these voltage values are also dependent on the alternating-current voltage Vin input to the converter.

### Structure of Electric Motor

Next, the structure of the electric motor (1) according to this embodiment will be described with reference to FIG. 24 to FIG. 26.

As illustrated in FIG. 24, the stator (11) of the electric motor (1) includes a stator core (30) and coils (33).

The stator core (30) includes a back yoke portion (31) and a plurality of teeth portions (32). The back yoke portion (31) is a portion formed as a substantially cylindrical shape. The back yoke portion (31) is formed of a magnetic material (e.g., electrical steel sheet).

The plurality of teeth portions (32) are portions that protrude from the inner circumference of the back yoke portion (31) toward the radially inward direction. The teeth portions (32) are formed as a single unit with the back yoke portion (31). Each of the teeth portions (32) is formed of a magnetic material (e.g., electrical steel sheet).

The coils (33) are wound around the plurality of teeth portions (32). The coils (33) are formed of an insulator-coated conductor (e.g., copper). A coil (33) is wound around each of the teeth portions (32) by concentrated winding. Note that the coils (33) may also be wound around the plurality of teeth portions (32) by distributed winding.

As illustrated in FIG. 24 and FIG. 25, the rotor (12) of the electric motor (1) includes a rotor core (40) and a plurality of permanent magnets (42).

The rotor core (40) is formed as a substantially cylindrical shape. The rotor core (40) is formed of a magnetic material (e.g., electrical steel sheet). In the rotor core (40), a plurality of magnet insertion holes (41) are formed to be arranged in the circumferential direction.

Each of the magnet insertion holes (41) is formed as a V shape having a convex toward the radially inward direction. Each of the magnet insertion holes (41) has two magnet insertion portions (41a) and two flux barrier portions (41b). The magnet insertion portions (41a) are portions that obliquely extend from the radially inward direction toward the radially outward direction. The flux barrier portions (41b) are cavity portions formed successively on the edge of the radially outward direction of the magnet insertion portions (41a). The flux barrier portions (41b) straightly extend along the outer circumferential surface of the rotor core (40).

Each of the permanent magnets (42) is formed as a flat rectangular parallelepiped. The permanent magnets (42) are inserted into the magnet insertion portions (41a) of the magnet insertion holes (41). For example, each of the permanent magnets (42) is, but not limited to, formed of a sintered magnet including a rare-earth element.

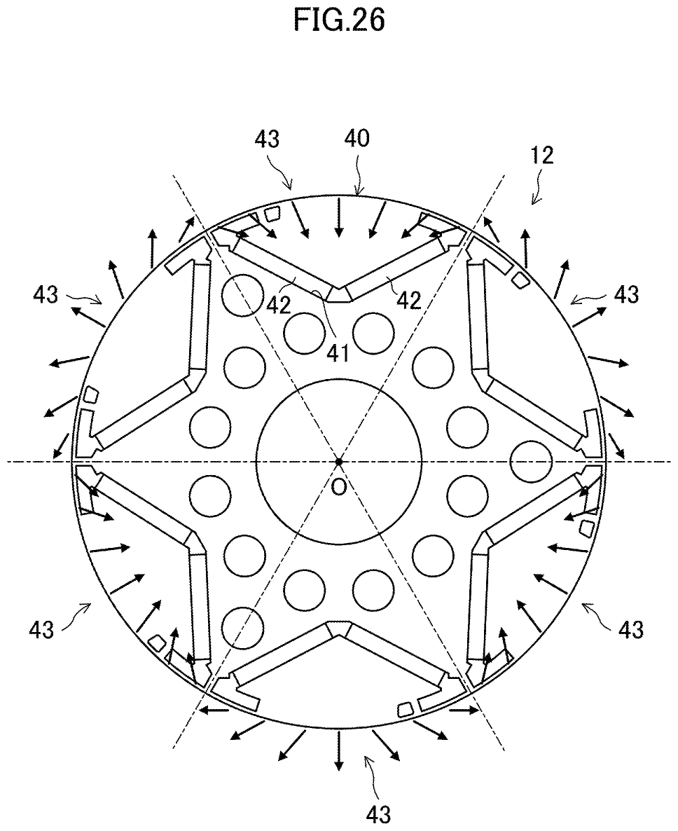

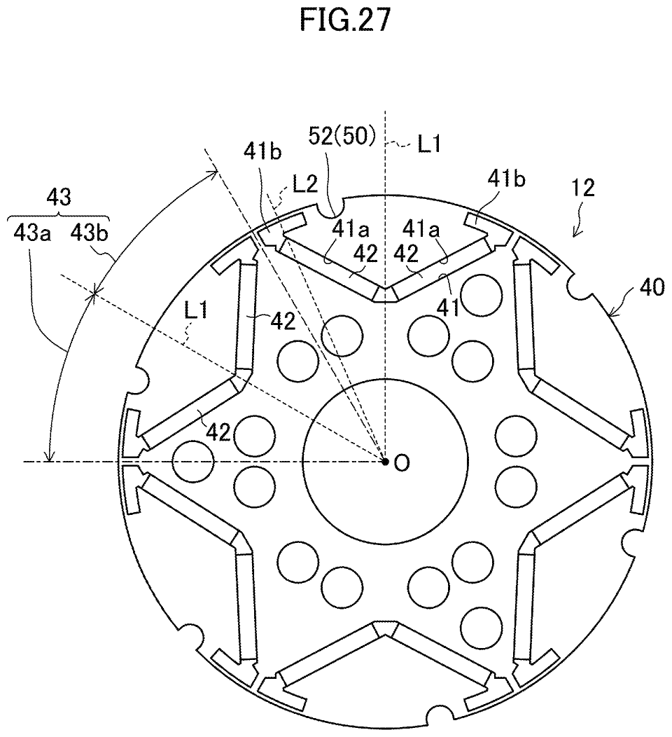

A pair of permanent magnets (42) inserted into the same magnet insertion hole (41) are magnetized so as to form one magnetic pole (43). The permanent magnets (42) in adjacent magnet insertion holes (41) form magnetic poles (43) having polarities opposite to each other. Herein, as illustrated in FIG. 26, “magnetic poles (43)” are regions obtained by dividing the rotor (12) in the circumferential direction depending on whether a magnetic field direction (denoted by arrows in FIG. 26) on a surface (specifically, outer circumferential surface) of the rotor (12) is the radially outward direction or the radially inward direction.

In this embodiment, six magnetic poles (43) having a substantially equal length in the circumferential direction are formed. Here, “length in the circumferential direction” of the magnetic pole (43) refers to the length in the circumferential direction of a region corresponding to each of the magnetic poles (43) on the outer circumferential surface of the rotor (12). In a case in which each of the magnetic poles (43) is divided into two, which are a rotation direction side and a reverse rotation direction side, relative to the pole center of the magnetic pole (43), the shape of a half portion (43a) on the rotation direction side and the shape of a half portion (43b) on the reverse rotation direction side are asymmetric about the pole center.

As illustrated in FIG. 25, in the rotor core (40), in a case in which each of the magnetic poles (43) is divided into two, which are the rotation direction side and the reverse rotation direction side, relative to the pole center of the magnetic pole (43), a cavity (51) as a magnetic resistance portion (51, 52) is formed in the half portion (43a) on the rotation direction side of all the magnetic poles (43). The cavity (51) is arranged in a more radially outward direction than the permanent magnet (42) in the rotor core (40). The cavity (51) is arranged between a straight line passing through an end portion on the rotation direction side in the permanent magnet (42) (more specifically, corner portion on the rotation direction side and the radially outward direction of the permanent magnet (42)) of the magnetic pole (43) and an axial center (O) of the rotor (12) and a straight line passing through the pole center of the magnetic pole (43) and the axial center (O) of the rotor (12).

The length in the circumferential direction of the cavity (51) is shorter than the length in the circumferential direction of the adjacent flux barrier portion (41b). The length in the radial direction of the cavity (51) is substantially equal to the length in the radial direction of the adjacent flux barrier portion (41b). The distance between the cavity (51) and the outer circumferential surface of the rotor (12) is substantially equal to the distance between the adjacent flux barrier portion (41b) and the outer circumferential surface of the rotor (12). The cavity (51) penetrates through the rotor core (40) in the axial direction. The cavity (51) forms magnetic saturation promoting means by which the half portion (43a) on the rotation direction side of the magnetic pole (43) is likely to be magnetically saturated.

### Effects of First Embodiment

The electric motor (1) according to this embodiment includes the rotor (12) and the stator (11). The rotor (12) has the rotor core (40), the shaft (10) inserted into and fixed to the rotor core (40), and the plurality of permanent magnets (42) forming the plurality of magnetic poles (43) arranged in the circumferential direction. The magnetic poles (43) are regions obtained by dividing the rotor (12) in the circumferential direction depending on whether a magnetic field direction on a surface of the rotor (12) is a radially outward direction or a radially inward direction. The shaft (10) is rotatably supported on the rotor core (40) only on one side of an axial direction. In a case in which each of the magnetic poles (43) is divided into two, which are a rotation direction side and a reverse rotation direction side, relative to a pole center of the magnetic pole (43), the rotor core (40) has a magnetic saturation promoting portion or means (50) by which the half portion (43a) on the rotation direction side of at least one of the magnetic poles (43) each including a corresponding one of the permanent magnets (42) is likely to be magnetically saturated. The magnetic saturation promoting means (50) is provided in a more radially outward direction than the permanent magnet (42). A shape of the half portion (43a) on the rotation direction side and a shape of the half portion (43b) on the reverse rotation direction side are asymmetric about a straight line (L1) passing through the pole center of the magnetic pole (43) and the axial center (O) of the rotor (12). Thus, by the magnetic saturation promoting means (50), the half portion (43a) on the rotation direction side of the magnetic pole (43) is likely to be magnetically saturated. This can reduce unbalanced magnetic pull generated in the electric motor (1).

Here, a generation mechanism of the unbalanced magnetic pull and reasons why the unbalanced magnetic pull is reduced by magnetic saturation will be described.

First, the generation mechanism of the unbalanced magnetic pull will be described. If the rotor (12) is decentered, in a region where the rotor (12) and the stator (11) are close to each other, the magnetic flux amount increases, and the magnetic pull in the radial direction between the rotor (12) and the stator (11) increases. On the other hand, in a region where the rotor (12) and the stator (11) are away from each other, the magnetic flux amount decreases, and the magnetic pull in the radial direction between the rotor (12) and the stator (11) decreases. Thus, the force in the radial direction that acts on the rotor (12) is unbalanced, and the unbalanced magnetic pull is generated.

Next, the reasons why the unbalanced magnetic pull is reduced by magnetic saturation will be described. If the vicinity of the outer circumferential surface of the rotor (12) is magnetically saturated, in the region where the rotor (12) and the stator (11) are close to each other, the magnetic flux amount is unlikely to increase for the magnetic saturation, and thus, the magnetic pull in the radial direction between the rotor (12) and the stator (11) is also unlikely to increase. Furthermore, if the vicinity of the outer circumferential surface of the rotor (12) is magnetically saturated, in the region where the rotor (12) and the stator (11) are away from each other, the magnetic flux amount is unlikely to decrease for the magnetic saturation, and thus, the magnetic pull in the radial direction between the rotor (12) and the stator (11) is also unlikely to decrease. Therefore, the force in the radial direction that acts on the rotor (12) is unlikely to be unbalanced, and the unbalanced magnetic pull is reduced by magnetic saturation in the rotor (12).

Furthermore, reasons why the half portion (43a) on the rotation direction side of the magnetic pole (43) is likely to be magnetically saturated will also be described. The inventors of the subject application have found out that most of the force of the radial direction that causes the unbalanced magnetic pull is generated in the half portion (43a) on the rotation direction side of the magnetic pole (43). Thus, the inventors have enabled efficient reduction of the unbalanced magnetic pull by making the half portion (43a) on the rotation direction side of the magnetic pole (43) likely to be magnetically saturated.

In addition, in the electric motor (1) according to this embodiment, the shape of the half portion (43a) on the rotation direction side and the shape of the half portion (43b) on the reverse rotation direction side are asymmetric about a straight line (L1) passing through the pole center of the magnetic pole (43) and the axial center (O) of the rotor (12), and also, the magnetic pole (43) has a shape by which the half portion (43a) on the rotation direction side is more likely to be magnetically saturated than the half portion (43b) on the reverse rotation direction side. This can reduce the unbalanced magnetic pull generated in the electric motor (1) and also can generate a large reactance torque in the electric motor (1). This is because the half portion (43b) on the reverse rotation direction side of the magnetic pole (43), which is relatively unlikely to be magnetically saturated, can be effectively used as a magnetic flux path for generating the reactance torque.

In addition, in the electric motor (1) according to this embodiment, the magnetic saturation promoting means (50) is the magnetic resistance portion (51, 52) provided in the half portion (43a) on the rotation direction side of the magnetic pole (43) in a more radially outward direction than the permanent magnet (42) in the rotor core (40). Thus, by the magnetic resistance portion (51, 52), the half portion (43a) on the rotation direction side of the magnetic pole (43) is likely to be magnetically saturated.

In addition, in the electric motor (1) according to this embodiment, the magnetic resistance portion (51, 52) is arranged between a straight line (L2) passing through an end portion on the rotation direction side in the permanent magnet (42) of the magnetic pole (43) and the axial center (O) of the rotor (12) and the straight line (L1) passing through the pole center of the magnetic pole (43) and the axial center (O) of the rotor (12). Thus, by devising the arrangement of the magnetic resistance portion (51, 52), the unbalanced magnetic pull can be further reduced.

In addition, in the electric motor (1) according to this embodiment, the magnetic resistance portion (51, 52) is the cavity (51) formed in the rotor core (40). Thus, the magnetic resistance portion (51, 52) can be formed by the cavity (51) at a low cost.

In addition, in the electric motor (1) according to this embodiment, the rotor (12) has the balance weights (13a, 13c) provided on both an end side of the axial direction and another end side of the axial direction of the rotor core (40), and the center of gravity of each of the balance weights (13a, 13c) is decentered from the axial center (O) of the rotor (12). Thus, even if the balance weights (13a, 13c) each having the center of gravity decentered from the axial center (O) of the rotor (12) is provided, since the unbalanced magnetic pull is reduced, an axial runout of the shaft (10) can be suppressed.

In addition, the compressor (100) according to this embodiment includes the casing (15), the electric motor (1) accommodated in the casing (15), and the compression mechanism (20) accommodated in the casing (15) and configured to be driven by the electric motor (1). Thus, even if the compression mechanism (20) is rotationally driven at a high speed by the electric motor (1), since the unbalanced magnetic pull is unlikely to be generated in the electric motor (1), the compression mechanism (20) can be appropriately driven with the axial runout of the shaft (10) suppressed.

In addition, the electric motor system (MS) according to this embodiment includes the electric motor (1) configured to drive the compression mechanism (20) by using rotation of the shaft (10), the inverter (210b) configured to output the application voltage (Vs), which is a voltage to be applied to the electric motor (1), and the controller (209) configured to drive control the inverter (210b). The controller (209) is configured to cause the inverter (210b) to output the application voltage (Vs) having an amplitude smaller than the first maximum (V_{max_}ω_{MAX}) and cause the electric motor (1) to rotate at the first speed (ω_{MAX}) and drive the compression mechanism (20), and cause the inverter (210b) to output the application voltage (Vs) having an amplitude of the second maximum (V_{max_}ω3) and cause the electric motor (1) to rotate at the second speed (ω3) and drive the compression mechanism (20). The first maximum (V_{max_}ω_{MAX}) is a possible maximum value of the amplitude (|Vs|) of the application voltage when the electric motor (1) drives the compression mechanism (20) at the first speed (ω_{MAX}). The first speed (ω_{MAX}) is a maximum of the speed (ωₘ) of rotation of the electric motor when the electric motor (1) drives the compression mechanism (20). The second maximum (V_{max_}ω3) is a possible maximum value of the amplitude (|Vs|) of the application voltage when the electric motor (1) drives the compression mechanism (20) at the second speed (ω3). The second speed (ω3) is lower than the first speed (ω_{MAX}). Thus, by the predetermined control of the inverter (210b) by the controller (209), the unbalanced magnetic pull generated in the electric motor (1) can be reduced.

Here, predetermined control according to this embodiment and the electric motor (1) according to this embodiment are extremely compatible with each other in order to obtain the effect of reducing the unbalanced magnetic pull. Specifically, if the predetermined control according to this embodiment is applied to a typical electric motor, the magnetic saturation in a rotor is relieved by the control (this increases the unbalanced magnetic pull), and thus, the effect of reducing the unbalanced magnetic pull can only be obtained to some extent. In contrast, if the predetermined control according to this embodiment is applied to the electric motor (1) according to this embodiment, since the magnetic saturation promoting means (specifically, the cavity (51)) is present, almost no magnetic saturation in the rotor (12) is relieved even if the control is applied, and the effect of reducing the unbalanced magnetic pull can be obtained as much as possible.

In addition, the electric motor system (MS) according to this embodiment includes the electric motor (1) configured to drive the compression mechanism (20) by using rotation of the shaft (10), the inverter (210b) configured to output the application voltage (Vs), which is a voltage to be applied to the electric motor (1), and the controller (209) configured to control the inverter (210b). In a case in which the speed (ωₘ) of rotation of the electric motor (1) when the electric motor (1) outputs a predetermined torque is higher than or equal to the base speed (cob) of the electric motor (1) when the electric motor (1) outputs the predetermined torque, the controller (209) is configured to cause the inverter (210b) to output the application voltage (Vs) having an amplitude obtained by multiplying the first maximum (V_{max_}ω1) by the first ratio, cause the electric motor (1) to rotate at the first speed (ω1), and cause the electric motor (1) to output the predetermined torque, and cause the inverter (210b) to output the application voltage (Vs) having an amplitude obtained by multiplying the second maximum (V_{max_}ω2) by the second ratio, cause the electric motor (1) to rotate at the second speed (ω2), and cause the electric motor (1) to output the predetermined torque. The first maximum (V_{max_}ω1) is a possible maximum value of the amplitude (|Vs|) of the application voltage when the electric motor (1) outputs the predetermined torque at the first speed (ω1). The second maximum (V_{max_}ω2) is a possible maximum value of the amplitude (|Vs|) of the application voltage when the electric motor (1) outputs the predetermined torque at the second speed (ω2). The second speed (ω2) is higher than the first speed (ω1). The second ratio is smaller than the first ratio. Thus, by the predetermined control of the inverter (210b) by the controller (209), the unbalanced magnetic pull generated in the electric motor (1) can be reduced.

### Modification of First Embodiment

A modification of the first embodiment will be described. The electric motor (1) according to this modification is different from that according to the first embodiment in the configuration of the magnetic saturation promoting means. Now, different points from the first embodiment will mainly be described.

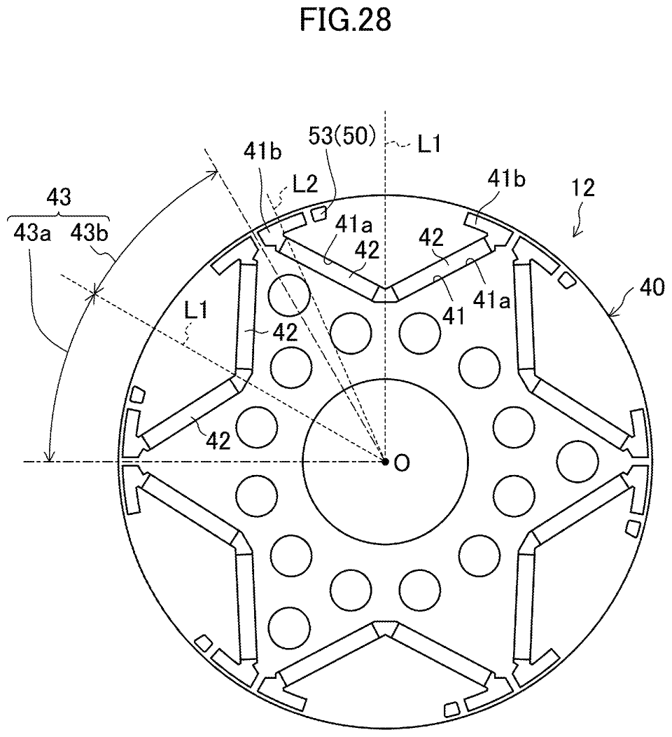

As illustrated in FIG. 27, on the outer circumferential surface of the rotor core (40), a concave portion (52) is formed for each of the magnetic poles (43). The concave portion (52) is provided on the half portion (43a) on the rotation direction side of all the magnetic poles (43). The concave portion (52) is arranged between the straight line passing through an end portion on the rotation direction side in the permanent magnet (42) (more specifically, corner portion on the rotation direction side and the radially outward direction of the permanent magnet (42)) of the magnetic pole (43) and the axial center (O) of the rotor (12) and the straight line passing through the pole center of the magnetic pole (43) and the axial center (O) of the rotor (12). The concave portion (52) extends over the entire length of the rotor core (40) in the axial direction. The concave portion (52) forms a magnetic resistance portion and forms the magnetic saturation promoting means.

### Effects of Modification of First Embodiment

Effects that are substantially the same as those in the first embodiment can be obtained by the electric motor (1), the compressor (100), and the electric motor system (MS) according to this modification.

In addition, in the electric motor (1) according to this modification, the above magnetic resistance portion (51, 52) is the concave portion (52) formed on the outer circumferential surface of the rotor core (40). Therefore, the magnetic resistance portion (51, 52) can be formed by the concave portion (52) at a low cost.

### Second Embodiment

A second embodiment will be described. The electric motor (1) according to this embodiment is different from that according to the first embodiment in the configuration of the magnetic saturation promoting means. Now, different points from the first embodiment will mainly be described.

As illustrated in FIG. 28, in the rotor core (40), part of the half portion (43a) on the rotation direction side of the magnetic pole (43), the part being in a more radially outward direction than the permanent magnet (42), is an easy magnetic saturation portion (53). The easy magnetic saturation portion (53) is a portion formed of a magnetic material (e.g., permalloy, amorphous metal material, or ferrite) having a lower saturation magnetic flux density than the magnetic material (e.g., electrical steel sheet) forming the portion other than the half portion (43a). The shape and the arrangement are substantially the same as those of the cavity (51) according to the first embodiment. The easy magnetic saturation portion (53) forms the magnetic saturation promoting means.

### Effects of Second Embodiment

Effects that are substantially the same as those in the first embodiment can be obtained by the electric motor (1), the compressor (100), and the electric motor system (MS) according to this embodiment.

In addition, in the electric motor (1) according to this embodiment, in the rotor core (40), at least part of the half portion (43a) on the rotation direction side of the magnetic pole (43), the part being in a more radially outward direction than the permanent magnet (42), is the easy magnetic saturation portion (53) formed of a magnetic material having a lower saturation magnetic flux density than the magnetic material forming the portion other than the half portion (43a). The easy magnetic saturation portion (53) forms the magnetic saturation promoting means (50). Therefore, by the easy magnetic saturation portion (53), the half portion (43a) on the rotation direction side of the magnetic pole (43) is likely to be magnetically saturated. This can reduce the unbalanced magnetic pull generated in the electric motor (1).

### Third Embodiment

A third embodiment will be described. The electric motor (1) according to this embodiment is different from that according to the first embodiment mainly in the number and the configuration of the magnetic poles (43) in the first embodiment. Now, different points from the first embodiment will mainly be described.

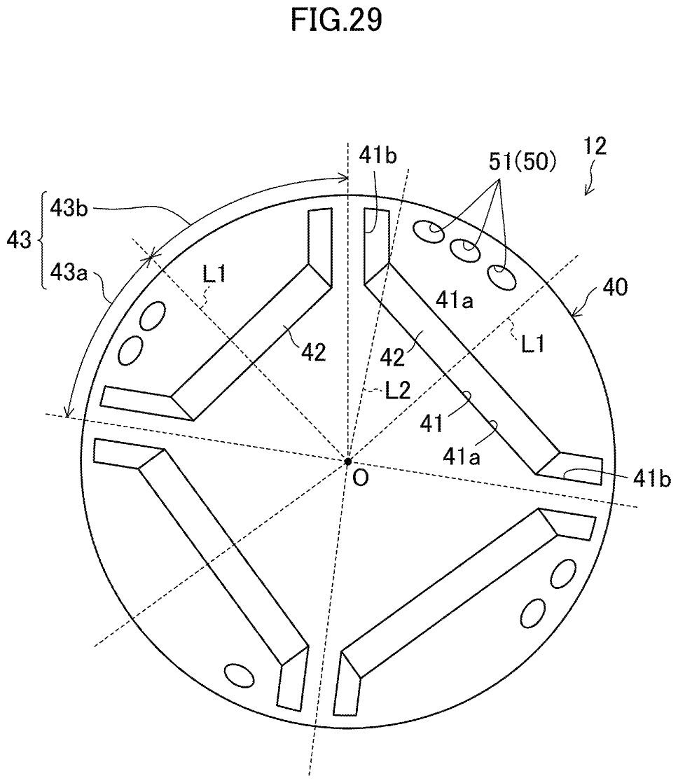

As illustrated in FIG. 29, in the rotor core (40), four magnet insertion holes (41) are formed to be arranged in the circumferential direction. Each of the magnet insertion holes (41) has a magnet insertion portion (41a) extending linearly in the circumferential direction and flux barrier portions (41b) extending from both ends of the magnet insertion portion (41a) toward radially outward direction.

The four magnet insertion holes (41) have different lengths in the circumferential direction from one another. Specifically, the length in the circumferential direction of the upper-right magnet insertion hole (41) in FIG. 29 is the longest, the length in the circumferential direction of the lower-right and lower-left magnet insertion holes (41) in FIG. 29 is the second longest, and the length in the circumferential direction of the upper-left magnet insertion hole (41) in FIG. 29 is the shortest.

Four permanent magnets (42) inserted in the magnet insertion portions (41a) of the respective magnet insertion holes (41) have different lengths in the circumferential direction from one another. Specifically, the length in the circumferential direction of the upper-right permanent magnet (42) in FIG. 29 is the longest, the length in the circumferential direction of the lower-right and lower-left permanent magnets (42) in FIG. 29 is the second longest, and the length in the circumferential direction of the upper-left permanent magnet (42) in FIG. 29 is the shortest.

With such a structure, four magnetic poles (43) have different lengths in the circumferential direction from one another. Specifically, the length in the circumferential direction of the upper-right magnetic pole (43) in FIG. 29 is the longest, the length in the circumferential direction of the lower-right and lower-left magnetic poles (43) in FIG. 29 is the second longest, and the length in the circumferential direction of the upper-left magnetic pole (43) in FIG. 29 is the shortest.

In FIG. 29, three cavities (51) as the magnetic resistance portion (51, 52) are formed to be arranged in the circumferential direction in the upper-right magnetic pole (43), two cavities (51) as the magnetic resistance portion (51, 52) are formed to be arranged in the circumferential direction in the lower-right and upper-left magnetic poles (43), and one cavity (51) as the magnetic resistance portion (51, 52) is formed in the lower-left magnetic pole (43).

### Effects of Third Embodiment

Effects that are substantially the same as those in the first embodiment can be obtained by the electric motor (1), the compressor (100), and the electric motor system (MS) according to this embodiment.

### Other Embodiments

The above embodiments may also employ the following configuration.

For example, although the magnetic saturation promoting means (50) is provided in all the magnetic poles (43) in each of the above embodiments, the magnetic saturation promoting means (50) may alternatively be provided only in one or some of the magnetic poles (43).

In addition, for example, the magnetic pole (43) of the rotor (12) may have a shape by which the half portion (43b) on the reverse rotation direction side is more likely to be magnetically saturated than the half portion (43a) on the rotation direction side.

In addition, the number of magnetic poles (43) of the rotor (12) is not limited to those in the above embodiments. The number of permanent magnets (42) of the magnetic poles (43) is not limited to those in the above embodiments either.

In addition, although the electric motor (1) is an interior magnet synchronous motor in each of the above embodiments, the electric motor (1) is not limited to this type. For example, the electric motor (1) may also be a consequent-pole electric motor.

Although the embodiments and modifications have been described above, it should be understood that various modifications can be made for forms or details without departing from the spirit and scope of the claims. The above embodiments and modifications can be combined or substituted unless the function of the subject matter of the present disclosure is degraded.

As described above, the present disclosure is useful for an electric motor and an electric motor system provided with the same.

1. An electric motor (1) comprising:
a rotor; and
a stator,
the rotor having
a rotor core,
a shaft inserted into and fixed to the rotor core, and
a plurality of permanent magnets forming a plurality of magnetic poles arranged in a circumferential direction,
the magnetic poles being regions obtained by dividing the rotor in the circumferential direction depending on whether a magnetic field direction on a surface of the rotor is a radially outward direction or a radially inward direction,
the shaft being rotatably supported on the rotor core only on one side of an axial direction,
in a case in which each of the magnetic poles is divided into two, which are a rotation direction side and a reverse rotation direction side, relative to a pole center of the magnetic pole,
the rotor core has magnetic saturation promoting portion by which a half portion on the rotation direction side of at least one of the magnetic poles each including a corresponding one of the permanent magnets is likely to be magnetically saturated,
the magnetic saturation promoting portion being provided in a more radially outward direction than the permanent magnet, and
a shape of the half portion on the rotation direction side and a shape of a half portion on the reverse rotation direction side are asymmetric about a first straight line passing through the pole center of the magnetic pole and an axial center of the rotor.

2. The electric motor according to claim 1, wherein
the magnetic saturation promoting portion is a magnetic resistance portion provided in the half portion on the rotation direction side of the magnetic pole in a more radially outward direction than the permanent magnet in the rotor core.

3. The electric motor according to claim 2, wherein
the magnetic resistance portion is arranged between
a second straight line passing through an end portion on the rotation direction side in the permanent magnet of the magnetic pole and the axial center of the rotor and
the first straight line passing through the pole center of the magnetic pole and the axial center of the rotor.

4. The electric motor according to claim 2, wherein
the magnetic resistance portion is a cavity formed in the rotor core.

5. The electric motor according to claim 2, wherein
the magnetic resistance portion is a concave portion formed on an outer circumferential surface of the rotor core.

6. The electric motor according to claim 1, wherein
in the rotor core, at least part of the half portion on the rotation direction side of the magnetic pole, the part being in a more radially outward direction than the permanent magnet, is an easy magnetic saturation portion formed of a magnetic material having a lower saturation magnetic flux density than a magnetic material forming a portion other than the half portion, and
the magnetic saturation promoting portion includes the easy magnetic saturation portion.

7. The electric motor according to claim 1, wherein
the rotor has a weight provided on at least one of a first end side of the axial direction and a second end side of the axial direction of the rotor core, and
a center of gravity of the weight is decentered from the axial center of the rotor.

8. A compressor including the electric motor according to claim 1, the compressor further comprising:
a casing with the electric motor accommodated therein; and
a compression mechanism accommodated in the casing and configured to be driven by the electric motor.

9. An electric motor system including the electric motor according to claim 1, the electric motor being configured to drive a load by using rotation of the shaft, the electric motor system further comprising:
an inverter configured to output an application voltage to be applied to the electric motor; and
a control unit configured to control the inverter, the control unit being configured to
cause the inverter to output the application voltage having an amplitude smaller than a first maximum and cause the electric motor to rotate at a first speed and drive the predetermined load, and
cause the inverter to output the application voltage having an amplitude of a second maximum and cause the electric motor to rotate at a second speed and drive the predetermined load,
the first maximum being a possible maximum value of an amplitude of the application voltage when the electric motor drives the predetermined load at the first speed,
the first speed being a maximum of a speed of rotation of the electric motor when the electric motor drives the predetermined load,
the second maximum being a possible maximum value of the amplitude of the application voltage when the electric motor drives the predetermined load at the second speed, and
the second speed being lower than the first speed.

10. An electric motor system including the electric motor according to claim 1, the electric motor being configured to drive a load by using rotation of the shaft, the electric motor system further comprising:
an inverter configured to output an application voltage to be applied to the electric motor; and
a control unit configured to control the inverter,
in a case in which a speed of rotation of the electric motor when the electric motor outputs a predetermined torque is higher than or equal to a base speed of the electric motor when the electric motor outputs the predetermined torque, the control unit is configured to
cause the inverter to output the application voltage having an amplitude obtained by multiplying a first maximum by a first ratio, cause the electric motor to rotate at a first speed, and cause the electric motor to output the predetermined torque, and
cause the inverter to output the application voltage having an amplitude obtained by multiplying a second maximum by a second ratio, cause the electric motor to rotate at a second speed, and cause the electric motor to output the predetermined torque,
the first maximum being a possible maximum value of an amplitude of the application voltage when the electric motor outputs the predetermined torque at the first speed,
the second maximum being a possible maximum value of the amplitude of the application voltage when the electric motor outputs the predetermined torque at the second speed,
the second speed being higher than the first speed, and
the second ratio being smaller than the first ratio.

11. The electric motor according to claim 3, wherein
the magnetic resistance portion is a cavity formed in the rotor core.

12. The electric motor according to claim 3, wherein
the magnetic resistance portion is a concave portion formed on an outer circumferential surface of the rotor core.

13. The electric motor according to claim 2, wherein
the rotor has a weight provided on at least one of a first end side of the axial direction and a second end side of the axial direction of the rotor core, and
a center of gravity of the weight is decentered from the axial center of the rotor.

14. The electric motor according to claim 3, wherein
the rotor has a weight provided on at least one of a first end side of the axial direction and a second end side of the axial direction of the rotor core, and
a center of gravity of the weight is decentered from the axial center of the rotor.

15. The electric motor according to claim 4, wherein
the rotor has a weight provided on at least one of a first end side of the axial direction and a second end side of the axial direction of the rotor core, and
a center of gravity of the weight is decentered from the axial center of the rotor.

16. The electric motor according to claim 5, wherein
the rotor has a weight provided on at least one of a first end side of the axial direction and a second end side of the axial direction of the rotor core, and
a center of gravity of the weight is decentered from the axial center of the rotor.

17. The electric motor according to claim 6, wherein
the rotor has a weight provided on at least one of a first end side of the axial direction and a second end side of the axial direction of the rotor core, and
a center of gravity of the weight is decentered from the axial center of the rotor.

18. The electric motor according to claim 11, wherein
the rotor has a weight provided on at least one of a first end side of the axial direction and a second end side of the axial direction of the rotor core, and
a center of gravity of the weight is decentered from the axial center of the rotor.

19. The electric motor according to claim 12, wherein
the rotor has a weight provided on at least one of a first end side of the axial direction and a second end side of the axial direction of the rotor core, and
a center of gravity of the weight is decentered from the axial center of the rotor.

20. A compressor including the electric motor according to claim 2, the compressor further comprising:
a casing with the electric motor accommodated therein; and
a compression mechanism accommodated in the casing and configured to be driven by the electric motor.
